(19) United States
(12) Patent Application Publication
(10) Pub. No.: US 2015/0230156 A1
(43) Pub. Date: Aug. 13, 2015

(54) BASE STATION AND RADIO TERMINAL

(71) Applicant: FUJITSU LIMITED, Kawasaki-shi (JP)

(72) Inventor: Hichirou Hayami, Machida (JP)

(21) Appl. No.: 14/614,602

(22) Filed: Feb. 5, 2015

(30) Foreign Application Priority Data
Feb. 13, 2014 (JP) 2014-025918

(51) Int. Cl. H04W 48/10

(52) U.S. Cl. CPC H04W 48/10

(57) ABSTRACT

A base station permitting a specified radio terminal with an access right to utilize the base station includes a controller to perform processes including counting down for a predetermined period when receiving a start instruction and permitting utilization of the base station by a general radio terminal without the access right when accepting access right information from the general radio terminal before expiration of the predetermined period.

### CROSS-REFERENCE TO RELATED APPLICATION

This application is based upon and claims the benefit of priority of the prior Japanese Patent Application No. 2014-025918, filed on Feb. 13, 2014, the entire contents of which are incorporated herein by reference.

### FIELD

Disclosure relates to a base station and a radio terminal.

### BACKGROUND

One of communication standards for cellular phones developed by the 3GPP is Long Term Evolution (LTE). LTE-Advanced (LTE-A) is a standard as a developed standard of LTE (LTE and LTE-A are collectively referred to as “LTE” hereinafter).

A function called Closed Subscriber Group (CSG) is provided in “Release 8” that is a 3GPP specification relating to LTE. More specifically, a group (CSG) of radio terminals (a radio terminal is called user equipment (UE)) which are permitted access to a specific base station is set. A radio terminal (referred to as a specific radio terminal) belonging to the CSG is permitted to utilize a cell formed by the specific base station (referred to as a CSG cell). One example of the specific base station forming a CSG cell is a femto base station installed indoors. The femto base station is called a Home-eNodeB (HeNB) in LTE.

A radio terminal belonging to no CSG (referred to as a general radio terminal) is unable to perform communication via a CSG cell even if the radio terminal is located near a specific base station. For this reason, a general radio terminal located near a specific base station performs communication via a public radio network (macrocell).

If the macrocell and a CSG cell are operated over an identical frequency band, the problem of mutual interference may occur depending on the location where the specific base station is installed. More specifically, an uplink interference with the CSG cell may occur when the general radio terminal communicates with the macrocell. Radio waves from the CSG cell may cause an interference to downlink communication of the general radio terminal.

In view of the above-described problem of interference, the CSG function is enhanced in “Release 9” that is a 3GPP specification relating to LTE. In addition to CSG mode in which only a specific radio terminal is permitted to utilize a CSG cell, a mode called “hybrid-type” mode (hybrid mode) is provided in “Release 9.” A specific base station acting in hybrid mode transmits broadcast information including a CSG-ID (an identifier of a CSG cell) and a one-bit flag indicating that the CSG cell is made open to general radio terminals.

Upon receipt of the above-described broadcast information, a general radio terminal treats the CSG cell as a macrocell and may perform communication via the CSG cell. As described above, when a specific base station acts in hybrid mode, both a specific radio terminal and a general radio terminal are capable of communication using the specific base station.

Techniques similar to hybrid mode include a mobile communication system configured to manage a specific mobile station which permits communication via a CSG cell under control of a HeNB and configured such that a general mobile station other than a specific mobile station makes a CSG cell a waiting cell only when broadcast information notifying that waiting in the CSG cell is permitted is received.

For more information, see International Publication No. WO 2009/057602.

Hybrid mode and the above-mentioned related art have problems below. For example, assume a case where a manager of a specific base station wishes to permit an owner of a general radio terminal (e.g., a guest) to utilize the specific base station. In this case, broadcast information which permits a general radio terminal other than a specific radio terminal to use the specific base station is transmitted in the related art. With this transmission, the specific base station is made available to an indefinite number of general radio terminals present in the neighborhood of the specific base station.

On this occasion, a plurality of general radio terminals present in the neighborhood of the specific base station may determine a cell formed by the specific base station as a waiting cell, as a result of receiving the broadcast information, and transmit radio connection requests to the specific base station, depending on the radio wave environment in the neighborhood of the specific base station. In this case, the radio connection requests may exceed the radio terminal capacity of the specific base station, and a general radio terminal to which the manager wishes to give permission for utilization or a specific radio terminal may fail to connect to the specific base station. Another possibility is that the load on the specific base station may increase as a result of connection of the general radio terminals to the specific base station to cause a communication failure concerning a radio terminal connected to the specific base station.

As described above, the related art is incapable of providing an environment in which the number of connections of general radio terminals that are permitted to utilize a specific base station can be curbed. For this reason, a specific radio terminal or a general radio terminal to which the manager wishes to give permission for utilization may be restricted in utilization of the specific base station, as a result of making the specific base station available to general radio terminals.

### SUMMARY

One of embodiments of the invention is a base station permitting a specified radio terminal with an access right to utilize the base station. The base station includes a controller to perform processes including counting down for a predetermined period when receiving a start instruction and permitting utilization of the base station by a general radio terminal without the access right when accepting access right information from the general radio terminal before expiration of the predetermined period.

The target and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of the configuration of a radio communication system to be employed according to an embodiment;

FIG. 2 is a diagram illustrating an example of the hardware configuration of abase station device which can be used as each of a general base station and a specific base station;

FIG. 3 is a diagram schematically illustrating processing to be executed by a CPU of a base station used as a specific base station;

FIG. 4 illustrates an example of the data structure of an access right management table;

FIG. 5 illustrates an example of the hardware configuration of a radio terminal;

FIG. 6 schematically illustrates processing to be executed by a CPU of a general radio terminal;

FIG. 7A is a sequence chart illustrating action when the general radio terminal sets a CSG cell for the specific base station as a waiting cell;

FIG. 7B is a sequence chart illustrating action when the general radio terminal sets the CSG cell for the specific base station as a waiting cell;

FIG. 8A illustrates an example of the format of a piece A of broadcast information indicating whether the mode is CSG mode or hybrid mode;

FIG. 8B illustrates an example of the format of a piece B of broadcast information used to transmit a CSG-ID storage instruction and a CSG-ID deletion instruction;

FIG. 8C illustrates an example of the format of a piece C of broadcast information into which a piece A of broadcast information and a piece B of broadcast information are integrated;

FIG. 9 is a flowchart illustrating an example of a process of transmitting a CSG-ID storage instruction to be executed by the CPU of the specific base station;

FIG. 10 is a flowchart illustrating an example of a CSG-ID storage process at the general radio terminal;

FIG. 11 is a flowchart illustrating an example of a waiting cell determination process;

FIG. 12 is a sequence chart illustrating an example of an attach procedure;

FIG. 13 is a flowchart illustrating an example of a process at the time of message receipt at the specific base station and illustrates the details of <2> to <4> in FIG. 12;

FIG. 14 is a sequence chart illustrating action at the time of CSG-ID deletion;

FIG. 15 is a flowchart illustrating a process example of a second CSG-ID deletion process (second deletion process);

FIG. 16 is a flowchart illustrating a process example of a third CSG-ID deletion process (third deletion process);

FIG. 17 is a flowchart illustrating a process example of a fourth CSG-ID deletion process (fourth deletion process);

FIG. 18 is a flowchart illustrating a process example of a fifth CSG-ID deletion process (fifth deletion process);

FIG. 19 is a sequence chart illustrating an example of action according to a second embodiment;

FIG. 20A illustrates an example of the format of a piece D of broadcast information indicating permission for or prohibition of communication by a general radio terminal;

FIG. 20B illustrates an example of the format of a piece E of broadcast information into which a piece A of broadcast information and a piece D of broadcast information are integrated;

FIG. 21 is a flowchart illustrating an example of a waiting cell determination process according to the second embodiment;

FIG. 22 illustrates an example of the configuration of a base station which can be employed as a specific base station according to a third embodiment;

FIG. 23 illustrates an example of the configuration of a radio terminal which can be employed as a general radio terminal according to the third embodiment;

FIG. 24 is a sequence chart illustrating action when the general radio terminal sets a CSG cell for the specific base station as a waiting cell, according to the third embodiment;

FIG. 25 is a sequence chart illustrating another form according to the third embodiment;

FIG. 26 illustrates an example of the configuration of a radio terminal which can be employed as a general radio terminal according to a fourth embodiment; and

FIG. 27 is a sequence chart illustrating action when the general radio terminal sets a CSG cell for a specific base station as a waiting cell, according to the fourth embodiment. (radio communication system) according to an embodiment;

### DESCRIPTION OF EMBODIMENTS

The embodiments below will describe a specific base station which permits utilization by a general radio terminal (connection of the general radio terminal) only when the specific base station accepts access right information from the general radio terminal during a predetermined period after receipt of a start instruction.

As for the specific base station, general radio terminals which are permitted to connect to the specific base station are limited to general radio terminals which accept access right information within a predetermined period. This allows curbing of the number of connections of general radio terminals to the specific base station. It is thus possible to avoid possible issues in hybrid mode, i.e., a problem associated with radio connection requests beyond capacity and a problem resulting from load growth caused by an increase in the number of connections of radio terminals to the specific base station.

The details of embodiments will be described below with reference to the drawings. Configurations according to the embodiments are illustrative only, and the present invention is not limited to the configurations according to the embodiments.

### First Embodiment

<Network Configuration>

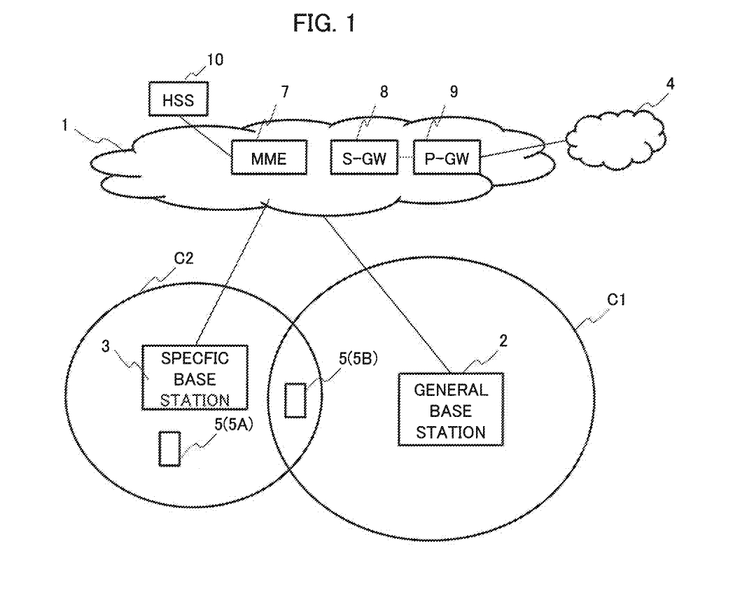

FIG. 1 illustrates an example of the configuration of a radio communication system (a radio access system or a mobile communication system) to be employed according to an embodiment. As an example of a radio communication system, an example of a system configuration conforming to LTE is illustrated.

An LTE network (an example of a mobile communication network) includes a radio network formed by abase station (eNB) and a core network which is connected to the radio network. The core network is called the Evolved Packet Core (EPC) or System Architecture Evolution (SAE). The radio network is called the Evolved Universal Terrestrial Radio Network (E-UTRAN).

A core network 1, a general base station 2 forming a macrocell C1, a specific base station 3 forming a CSG cell C2, and a radio terminal 5 are illustrated in FIG. 1. The general base station 2 is, for example, abase station of a public radio network. Since the general base station 2 generally forms a cell (the macrocell C1) larger than the CSG cell C2 formed by the specific base station 3, the general base station 2 is called a macrocell base station. The general base station 2 can be utilized regardless of whether the radio terminal 5 belongs to a CSG.

The specific base station 3 is abase station for which a group called a CSG is set. The radio terminals 5 are each classified as a radio terminal 5A which belongs to a CSG set for the specific base station 3 or a radio terminal 5B which does not belong to the CSG set for the specific base station 3. Belonging to the CSG means to have a right of access to the specific base station 3 (being registered at the specific base station 3). Not belonging to the CSG means not having a right of access to the specific base station 3 (being not registered at the specific base station 3).

Hereinafter the radio terminal 5A is referred to as the “specific radio terminal 5A.” The radio terminal 5B is referred to as the “general radio terminal 5B.” If distinction between the specific radio terminal 5A and the general radio terminal 5B is unnecessary, the wording of the “radio terminal 5” is used.

The specific base station 3 acts in at least two modes including CSG mode and hybrid mode. In CSG mode, permission for utilization of the specific base station 3 is given to the specific radio terminal 5A among the radio terminals 5 present in the neighborhood of the specific base station 3. In contrast, in hybrid mode, the specific base station 3 (the CSG cell C2) is available not only to the specific radio terminal 5A but also to the general radio terminal 5B.

The specific base station 3 is installed for various purposes, such as taking countermeasures against a dead zone in the macrocell C1 and increasing communication capability. In the present embodiment, the specific base station 3 is assumed to be a HeNB which is installed indoors and is managed by a given manager.

Note that the specific base station 3 may be installed and located indoors or outdoors. The size (cell radius) of a cell formed by the specific base station 3 does not matter. Examples of the specific base station 3 include a base station forming a cell larger in cell radius than a femto cell and a pico cell, in addition to a femto base station and a pico base station. The specific base station 3 may be installed for personal use or public use.

The core network 1 is connected to an external network 4. Examples of the external network 4 include the Internet and an intranet. In the core network 1, a plurality of devices called “core network devices” are installed.

In FIG. 1, a mobility management entity (MME) 7, a serving gateway (S-GW) 8, and a packet data network gateway (P-GW) 9 which is connected to the S-GW 8 are included as major core network devices. The MME 7 is connected to a home subscriber server (HSS) 10.

The MME 7 is an access gateway for the C-plane (Control plane) which handles network control. The MME 7 performs sequence and handover control, location management of the radio terminal 5 during waiting (location registration of the radio terminal 5), paging at the time of arrival of a call to a base station device (the general base station 2 or the specific base station 3), authentication of the radio terminal 5 (the NAS (Non-Access Stratum)), and the like. The MME 7 performs the location management and the authentication processing in conjunction with the home subscriber server (HSS) 10. The HSS 10 is a server which stores the contract information and the information for authentication of a user (subscriber) and stores (registers) the location information of the radio terminal 5.

The S-GW 8 is a gateway which handles user data (a user packet) and performs a process of connecting LTE user data to a 2G (e.g., GSM (registered trademark)) system or a 3G (W-CDMA) system. The P-GW 9 is a gateway for connecting user data to the external network 4. The P-GW 9 performs collection of billing data, Quality of Service (QoS) control, packet filtering, and the like.

Note that although a network configuration related to LTE is described as a network configuration, the network configuration is illustrative only. The configuration below of the embodiment can be applied to a base station, utilization of which is limited to a specific radio terminal, in a radio network conforming to a communication standard other than LTE.

<Example of Hardware Configuration of Base Station>

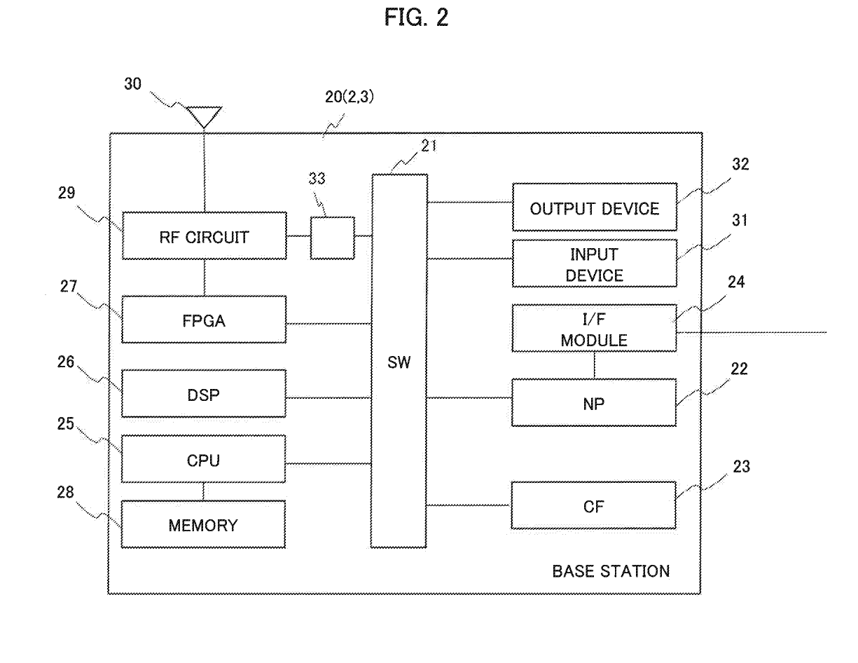

FIG. 2 is a diagram illustrating an example of the hardware configuration of a base station device 20 which can be used as each of the general base station 2 and the specific base station 3. In FIG. 2, the base station device 20 (hereinafter referred to as the base station 20) includes an internal switch (SW) 21, a network processor (NP) 22 which is connected to the internal switch 21, and a CompactFlash (registered trademark) (CF) 23. The NP 22 is connected to an interface module 24 (I/F 24), and the I/F 24 has a communication line (S1 line) which is connected to the core network 1. Note that the base station 20 is connected to the MME 7 via the S1-MME interface in the S1 line. The base station 20 is connected to the S-GW 8 via the S1-U interface in the S1 line.

The base station 20 also includes a central processing unit (CPU) 25, a digital signal processor (DSP) 26, and a field programmable gate array (FPGA) 27. The CPU 25 is connected to a memory 28. The FPGA 27 is connected to a radio frequency (RF) circuit 29, and the RF circuit 29 is connected to a transmitting and receiving antenna 30. The RF circuit 29 is an example of a transmitting device.

The base station 20 performs processing related to the U-plane and processing related to the C-plane (Control plane). The U-plane-related processing includes, for example, a process of transferring data (user data) received from the radio terminal 5 (a user) to the core network 1 (uplink transmission) and a process of transferring user data received from the core network 1 to the radio terminal 5 (downlink transmission). The C-plane-related processing includes transmission and reception of a control signal to and from the MME 7 or the like, transmission and reception of a control signal to and from the radio terminal 5, and control of action of the base station 20 using a control signal received from the MME 7 or the radio terminal 5.

The SW 21 is responsible for transmission and reception processing of a signal between circuits connected to the SW 21. The NP 22 and the I/F 24 function as a line interface with the core network 1. The NP 22 performs, for example, processing related to an Internet Protocol (IP) packet in a signal received by the I/F 24 and an IP packet to be transmitted to the I/F 24 (IP protocol processing). The I/F 24 performs a process of converting an IP packet received from the NP 22 into a signal to be transmitted to the core network 1, a process of converting a signal received from the core network 1 into an IP packet, and the like.

The DSP 26 acts as a BB processing section which performs digital baseband processing (BB processing) on user data. For example, the DSP 26 performs a process of converting, through digital modulation, user data or a control signal (control information) received from the NP 22 via the SW 21 into a baseband signal (BB signal) and a process of performing demodulation processing on a BB signal received from the FPGA 27 via the SW 21 to obtain user data or a control signal (control information).

The FPGA 27 acts as an orthogonal modulation and demodulation section which performs orthogonal modulation and demodulation processing as analog BB processing. That is, the FPGA 27 performs orthogonal modulation processing on a BB signal received from the DSP 26 via the SW 21, converts the BB signal into an analog signal, and sends the analog signal to the RF circuit 29. The FPGA 27 performs orthogonal demodulation processing on an analog signal received from the RF circuit 29, converts the analog signal into a BB signal, and sends the BB signal to the DSP 26.

The RF circuit 29 is responsible for radio processing in a downlink direction (from the base station 20 to the radio terminal 5) and in an uplink direction (from the radio terminal 5 to the base station 20). For the downlink direction, the RF circuit 29 includes an up-converter and a power amplifier (PA). For the uplink direction, the RF circuit 29 includes a low noise amplifier (LNA) and a down-converter. The RF circuit 29 includes a duplexer as a component common to downlink and uplink. The duplexer is connected to the transmitting and receiving antenna 30.

The up-converter up-converts an analog signal (RF signal) received from the FPGA 27 to a radio-wave frequency. The PA amplifies the up-converted signal. The duplexer connects the amplified signal to the transmitting and receiving antenna 30, and the transmitting and receiving antenna 30 emits radio waves. The emitted radio waves form a cell and are received by the radio terminal 5.

Radio waves received by the transmitting and receiving antenna 30 are input to the LNA via the duplexer and are subjected to low noise amplification in the LNA. A signal obtained through the low noise amplification is down-converted to a frequency for an analog signal (RF signal) by the down-converter. The down-converted signal is input to the FPGA 27.

The memory 28 is an example of a main storage and includes, for example, a random access memory (RAM) and a read only memory (ROM). The memory 28 is used as a work area for the CPU 25. The CF 23 is an example of an auxiliary storage and stores data used to control action of the base station 20 and programs to be executed by the CPU 25 and the DSP 26. The data includes, for example, information included in a synchronization signal and information to be broadcast as broadcast information.

The broadcast information includes pieces of basic information, such as a system bandwidth, a system frame number (SFN), and the number of transmitting antennas, called master information block (MIB) information. The broadcast information also includes system information block (SIB) information (also called system information (SI)) other than the MIB information.

The SI includes a cell global identity (CGI), a tracking area identity (TAI), a CSG-ID, and the like. A CGI is an identifier for uniquely identifying a cell all over the world. A TAI is given for each area, and a location is registered on an area-by-area basis in LTE. A CSG-ID is the identifier of a CSG. The SI further includes various pieces of information to be broadcast (publicized) as broadcast information, such as information indicating the mode of the specific base station 3 (CSG or hybrid) and a CSG-ID storage instruction and a CSG-ID deletion instruction to be described later.

The CPU 25 performs various processes related to the C-plane through exchange of a control signal (control information) between the MME 7 and the radio terminal 5. For example, the CPU 25 performs call processing (attachment, call origination, call termination, and detachment) of the radio terminal 5 and maintenance and operation (operation administration and maintenance (0AM)) processing of the base station 20. The CPU 25 also performs control of transmission of a synchronization signal and broadcast information and handover-related processing.

An input device 31 includes at least one of a key, a button, a touch panel, and a microphone and is used to enter information. In the present embodiment, the input device 31 is used by an operator (e.g., a manager) of the specific base station 3 to perform operation and enter input to permit the general radio terminal 5B to connect to the specific base station 3. For example, the input device 31 is used to enter an instruction to start counting down for a predetermined period, an instruction to start transmitting predetermined broadcast information, an instruction to stop counting down for the predetermined period, and an instruction to stop transmitting the broadcast information.

An output device 32 includes at least one of a display, a lamp, a speaker, and a vibrator and outputs information. In the present embodiment, for example, the output device 32 outputs pieces of information indicating the start and end of a transmission period for each of a CSG-ID storage instruction and a CSG-ID deletion instruction through display of information, lighting-up or blinking of a lamp, vibration of a vibrator, or the like.

Although not illustrated, the base station 20 can have a communication interface (at least one of wired and wireless communication interfaces) with an information processing device (e.g., a personal computer (PC), a workstation (WS), a tablet terminal, or a radio terminal). In this case, the base station 20 can receive a signal including information equivalent to information input from the input device 31 from the information processing device via a network (communication channel). The input device 31 can be omitted. Alternatively, contents (e.g., information to be displayed on a display) output from the output device 32 may be transmitted to an information processing device and be displayed on a display device of the information processing device. In this case, the output device 32 can be omitted.

The base station 20 used as the specific base station 3 includes an electric power controlling circuit 33 which is connected to the SW 21 and the RF circuit 29. The electric power controlling circuit 33 controls transmission power when the RF circuit 29 transmits radio waves through the transmitting and receiving antenna 30 in accordance with an instruction from the CPU 25. The base station 20 transmits various pieces of broadcast information toward the radio terminal 5 located in the neighborhood of the base station 20. The electric power controlling circuit 33 makes transmission power when a piece of broadcast information including a CSG-ID storage instruction to be described later is transmitted lower than transmission power for another piece of broadcast information (e.g., a piece of broadcast information indicating CSG mode).

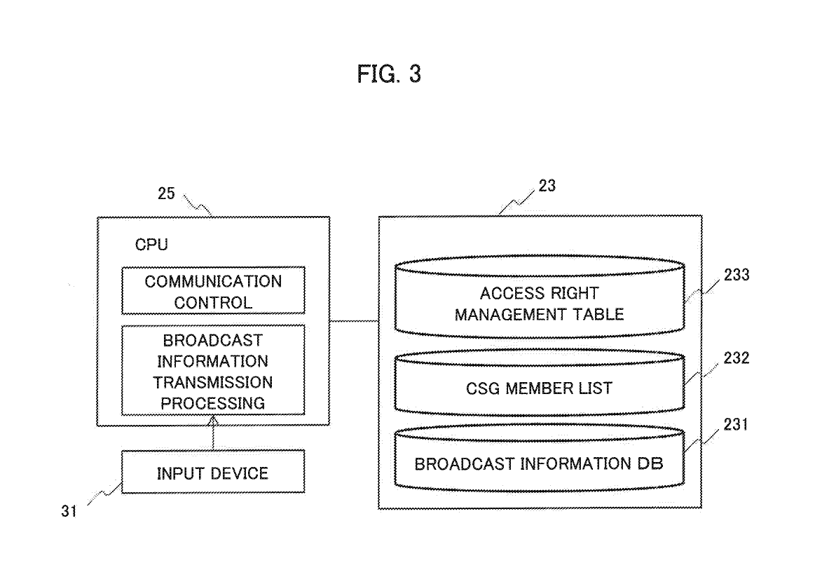

FIG. 3 schematically illustrates processing to be executed by the CPU 25 of the base station 20 used as the specific base station 3. At least one of the CF 23 and the memory 28 stores a broadcast information database (broadcast information DB) 231, a CSG member list 232, and an access right management table 233. FIG. 3 illustrates an example in which the broadcast information DB 231, the CSG member list 232, and the access right management table 233 are stored in the CF 23.

The broadcast information DB 231 stores pieces of information (MIB information, SIB information, and the like) to be included in a synchronization signal and broadcast information broadcast to the radio terminal 5. The CSG member list 232 is a list indicating the specific radio terminal 5A (a CSG member: a CSG user) belonging to a CSG set for the specific base station 3. For example, the identifier(s) (the terminal ID(s)) of one or two or more specific radio terminals 5A are stored in the CSG member list 232.

The access right management table 233 is a table for managing the specific radio terminal 5A (a CSG user) and the general radio terminal 5B (a temporary user), which is permitted to temporarily utilize the specific base station 3.

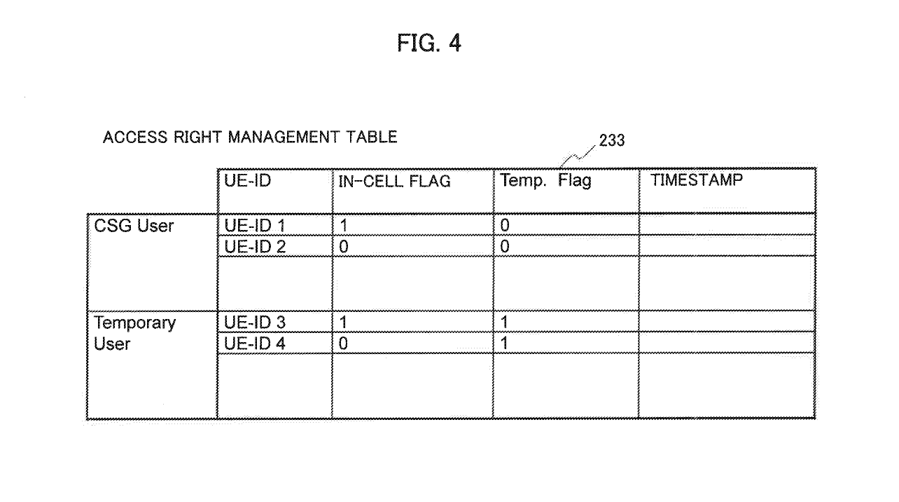

FIG. 4 illustrates an example of the data structure of the access right management table 233. In FIG. 4, a terminal ID (UE-ID), an in-cell flag, a temporary flag, and a time-stamp are stored for each of CSG users and temporary users.

Terminal IDs are the identifiers of a CSG user (the specific radio terminal 5A) and a temporary user (the general radio terminal 5B). An in-cell flag indicates whether a corresponding user (the radio terminal 5) is in the cell C2 of the specific base station 3 (hereinafter referred to as the “CSG cell C2”). For example, an in-cell flag of “1” indicates that the radio terminal 5 is in the cell while an in-cell flag of “0” indicates that the radio terminal 5 is out of the cell. Note that the meanings of “1” and “0” may be reversed. A temporary flag is set to “0” for the specific radio terminal 5A, and a temporary flag is set to “1” for the general radio terminal 5B. Whether the radio terminal 5 is a CSG user or a temporary user can be determined by the temporary flag. A time-stamp is optional, and, for example, a date and time or a time when the corresponding radio terminal 5 is in the cell is stored.

Note that the present embodiment adopts a configuration in which the CSG member list 232 and the access right management table 233 are prepared, the CSG member list 232 stores master data of CSG members, and ones actually in the cell of the specific base station 3 among the CSG members are recorded in the access right management table 233. Note that entries for all CSG members registered in the CSG member list 232 maybe registered as CSG users of the access right management table 233 and that the CSG member list 232 may be omitted.

The CPU 25 performs at least broadcast information transmission processing as illustrated in FIG. 3 and communication control by loading a program stored in the CF 23 into the memory 28 and executing the program. In the broadcast information transmission processing, the CPU 25 generates a synchronization signal and various pieces of broadcast information using information stored in the broadcast information DB 231 and gives the synchronization signal and the various pieces of broadcast information to the DSP 26 as the BB processing section. A synchronization signal and broadcast information are mapped to a predetermined position (on a channel) in a radio frame and transmitted in BB processing.

In the communication control, the CPU 25 performs radio connection processing (RRC (Radio Resource Control) connection processing: random access) between the radio terminal 5 and the specific base station 3. The CPU 25 also performs call processing, such as attach processing (location registration and bearer setting processing), detach processing (disconnection processing), call origination processing, or call termination processing in the communication control. A bearer refers to a transmission channel for user data. The CPU 25 also performs processing related to acceptance of a CSG-ID (an example of access right information) from the general radio terminal 5B in the communication control.

<Example of Configuration of Radio Terminal>

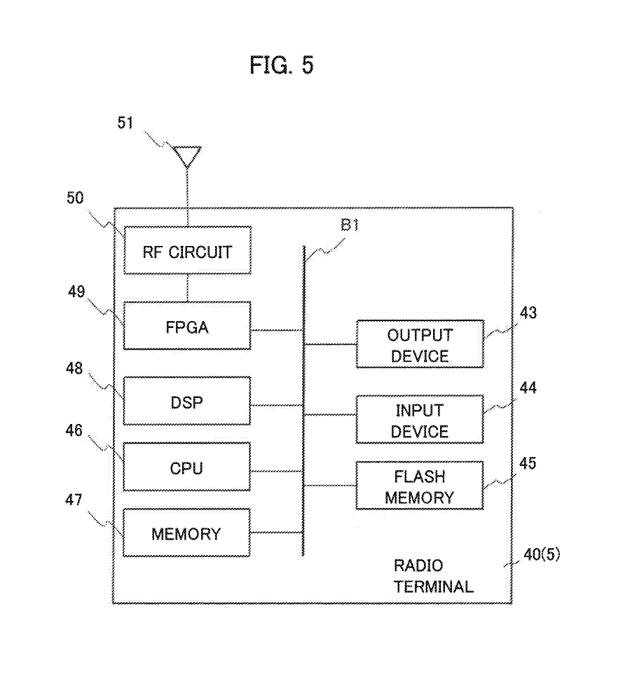

FIG. 5 illustrates an example of the hardware configuration of a radio terminal 40 which can be employed as the radio terminal 5. The radio terminal 40 includes an output device 43, an input device 44, a flash memory 45, a CPU 46, a memory 47, a DSP 48, an FPGA 49, and an RF circuit 50 which are interconnected via a bus B1. The RF circuit 50 is connected to a transmitting and receiving antenna 51.

The output device 43 includes a display device and a voice output device (speaker). The output device 43 can include a lamp and a vibrator. The input device 44 includes at least one of a button, a key, and a touch panel and a voice input device (microphone). The flash memory 45 is an example of an auxiliary storage and stores a program to be executed by the CPU 46 or the DSP 48 and data used upon execution of the program.

The CPU 46 executes various programs (applications) stored in the flash memory 45. With this execution, the CPU 46 executes various functions, such as a telephonic communication function, a Web terminal function, and an e-mail function. The memory 47 is an example of a main storage and is, for example, a ROM or a RAM. The memory 47 is used as a work area for the CPU 46.

The DSP 48 acts as a BB processing section which performs digital baseband processing, like the DSP 26 illustrated in FIG. 4. The FPGA 49 acts as an orthogonal modulation and demodulation section, like the FPGA 27 (FIG. 4). The RF circuit 50 has the same configuration and function as the RF circuit 29 and performs processing related to a radio signal. The transmitting and receiving antenna 51 transmits and receives a radio signal to and from the base station 20.

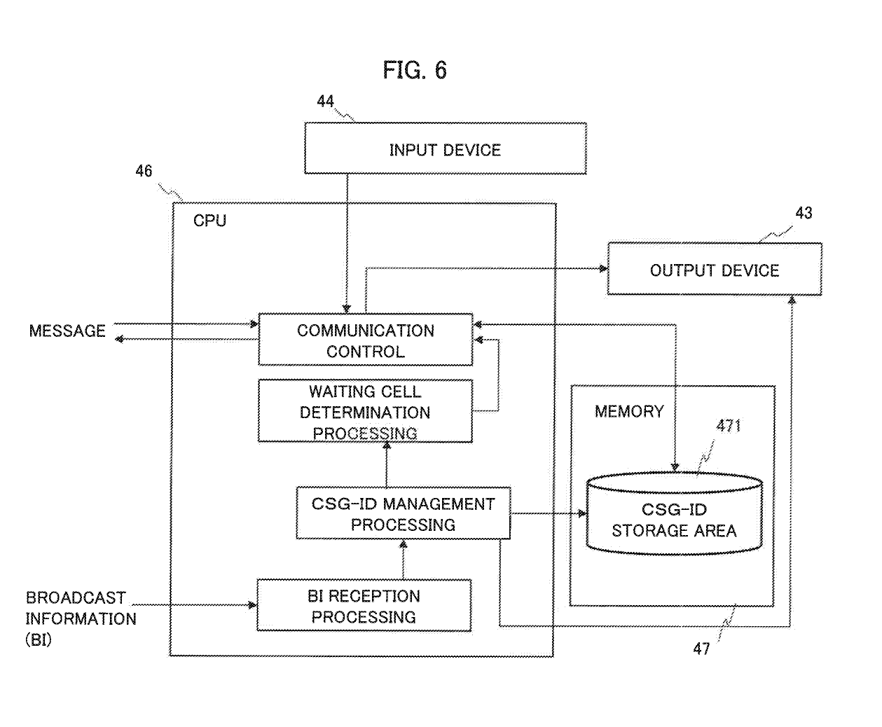

FIG. 6 schematically illustrates processing to be executed by the CPU 46 of the radio terminal 40 used as the general radio terminal 5B. A CSG-ID storage area 471 storing a CSG-ID received from the specific base station 3 is provided in the flash memory 45 or the memory 47 (the memory 47 in this example).

In the present embodiment, a CSG-ID stored in the CSG-ID storage area 471 is used as access right information indicating that utilization of the specific base station 3 by the general radio terminal 5B is permitted. That is, a CSG-ID is an example of “access right information.” Note that “access right information” may be information other than a CSG-ID and may be a combination of a CSG-ID and information other than a CSG-ID.

The CPU 46 performs at least broadcast information (BI) reception processing, CSG-ID management processing, waiting cell determination processing, and communication control by loading a program stored in the flash memory 45 into the memory 47 and executing the program. In the broadcast information reception processing, the CPU 46 interprets broadcast information. In the CSG-ID management, the CPU 46 stores a CSG-ID in the CSG-ID storage area 471 in accordance with a CSG-ID storage instruction included in broadcast information. In the CSG-ID management, the CPU 46 also deletes a CSG-ID stored in the CSG-ID storage area 471 in accordance with a CSG-ID deletion instruction included in broadcast information.

In the waiting cell determination processing, the CPU 46 determines a waiting cell for the general radio terminal 5B. In the communication control, the CPU 46 performs random-access-related processing (e.g., transmission of a radio connection request message (RACH preamble)) for radio connection (RRC connection) to a base station forming a cell determined as a waiting cell.

The CPU 46 also performs, as the communication control, location registration of the general radio terminal 5B via a base station connected by radio and processing related to an attach procedure for setting a bearer. The attach procedure is a procedure for registering the radio terminal 5 in a network and includes location registration of the radio terminal 5.

The CPU 46 performs call origination processing including transmission of a call origination request (SERVICE REQUEST) in response to a call origination operation using the input device 44. The CPU 46 controls a calling action (e.g., output of a ringing tone, display on a display, or vibration using a vibrator) of the output device 43 upon receipt of a calling signal (paging signal) from a base station, as call termination processing. The CPU 46 transmits a response signal to a base station in response to a response operation using the input device 44, as call termination processing. In the communication control, judgment (check) processing as to whether connection to the specific base station 3 is permitted is executed.

The CPU 46 includes a CSG-ID stored in the CSG-ID storage area 471 in a predetermined message related to communication control (control message). The predetermined message is, for example, an attach request message (ATTACH REQUEST). Note that a CSG-ID may be included in a call origination request message, instead of an attach request. Alternatively, a CSG-ID may be included both in an attach request and a call origination request.

Note that the CPU 25 and the CPU 46 illustrated in FIGS. 2 and 5 are examples of a “processor,” and the “processor” is an example of a “control device.” A function to be executed by each of the CPU 25 and the CPU 46 may be implemented by hardware logic (wired logic) of a piece of hardware functioning as a “control device.”

The piece of hardware functioning as the “control device” is composed of, for example, at least one of an electrical and electronic circuit, an integrated circuit (e.g., at least one of an IC, an LSI, and an application-specific integrated circuit (ASIC), and a programmable logic device (PLD), such as an FPGA. In this case, one piece of hardware may execute a plurality of functions or a combination of a plurality of pieces of hardware may execute one function.

Each of the CF 23 and the memory 28 illustrated in FIG. 2 and the flash memory 45 and the memory 47 illustrated in FIG. 5 is an example of a “storage device” or a “memory” which is a computer-readable storage medium.

<Example of Action>

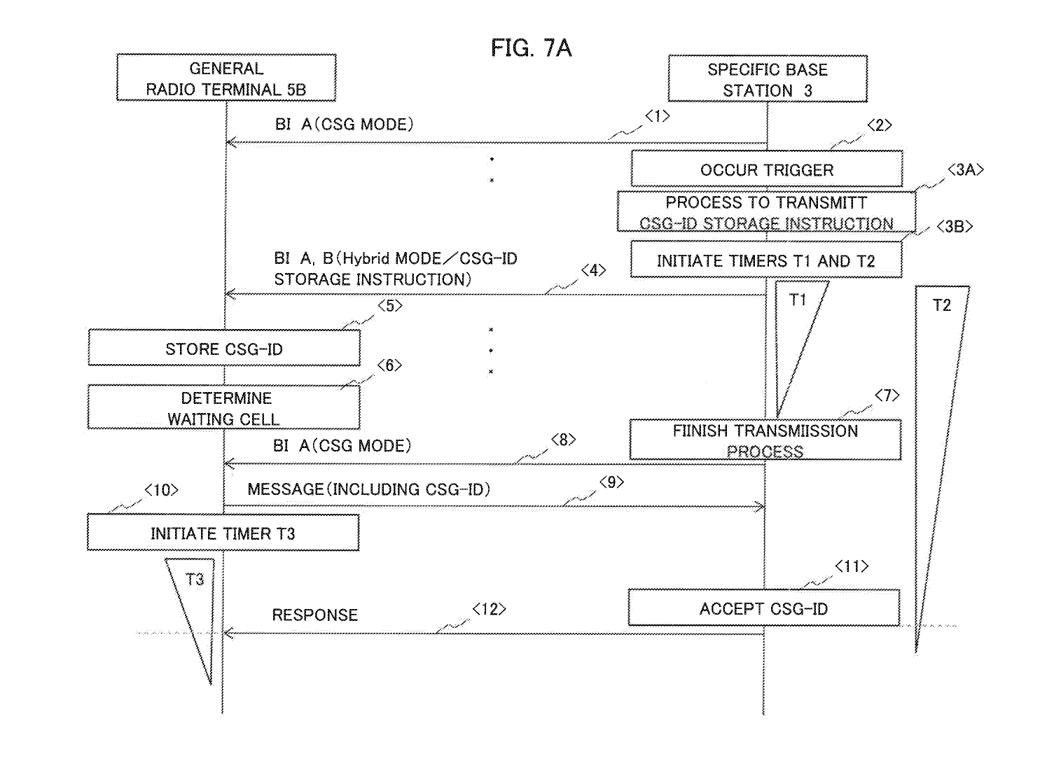

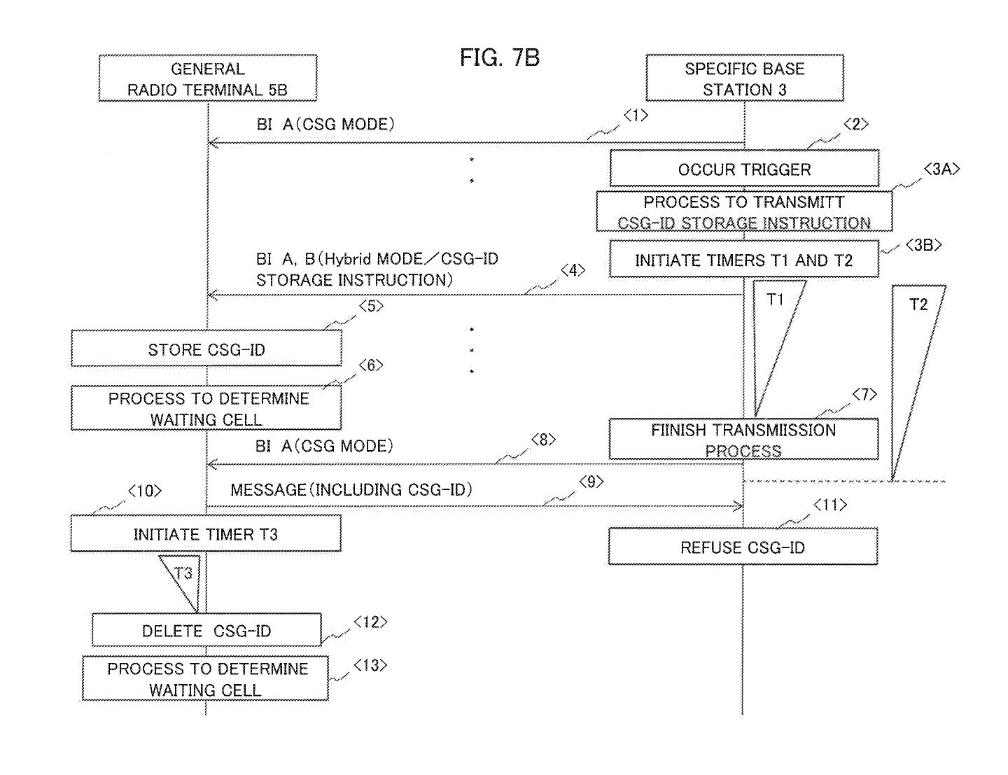

An example of action in the above-described radio communication system will be described below. FIGS. 7A and 7B are sequence charts illustrating action when the general radio terminal 5B sets the CSG cell C2 for the specific base station 3 as a waiting cell.

The sequence in FIG. 7A is based on, for example, the assumption that a manager of the specific base station 3 wishes to permit an owner of the general radio terminal 5B (e.g., a guest) to perform communication using the specific base station 3. At the start of the sequence, the specific base station 3 is acting in CSG mode, and utilization of (connection to) the specific base station 3 is limited to the specific radio terminal 5A. In CSG mode, the specific base station 3 transmits broadcast information indicating CSG mode throughout the CSG cell C2 (<1> in FIG. 7A).

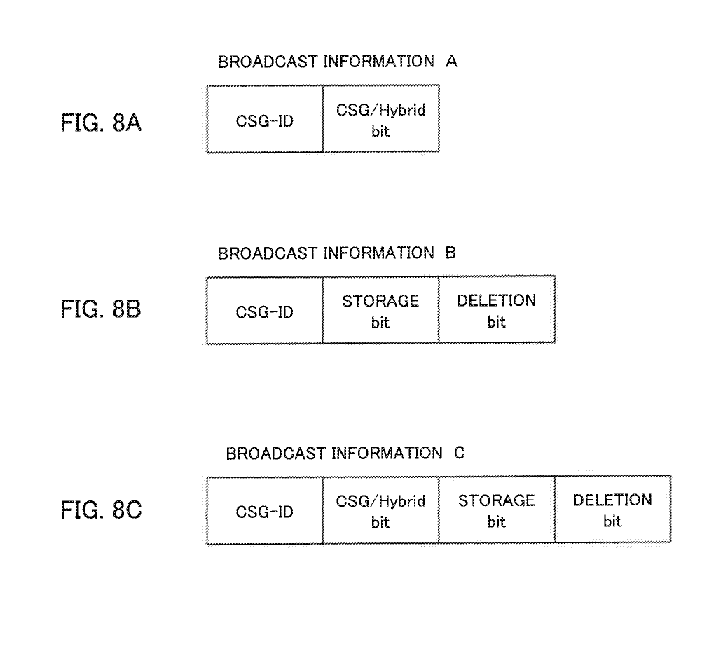

FIG. 8A illustrates an example of a format of broadcast information A indicating whether the mode is CSG mode or hybrid mode. The broadcast information A includes a CSG-ID and one bit (a CSG/hybrid bit) indicating whether the mode is CSG mode or hybrid mode. For example, a bit value of “0” indicates CSG mode while a bit value of “1” indicates hybrid mode. Note that broadcast information is mapped to the PDSCH (Physical Downlink Shared Channel) at the specific base station 3 and is transmitted.

In <1> of FIG. 7A, the broadcast information A with a CSG/hybrid bit of “0” is transmitted. The general radio terminal 5B is synchronized with the specific base station 3 as a result of a cell search and can receive the broadcast information A. The general radio terminal 5B refers to a CSG-ID and a CSG/hybrid bit of the broadcast information A.

At this time, since the general radio terminal 5B does not belong to a CSG indicated by the CSG-ID, and the mode of the specific base station 3 is CSG mode, the general radio terminal 5B abandons the broadcast information A under the judgment that utilization of the specific base station 3 is not permitted (the cell is unable to be set as awaiting cell). For this reason, the general radio terminal 5B does not execute interpretation of SIB information subsequent to the CSG/hybrid bit and processing based on the interpretation.

The manager of the specific base station 3 generates a trigger for transmission of a CSG-ID storage instruction by operation of the input device 31 (FIG. 2) (<2> in FIG. 7A). The trigger is generated, for example, when a predetermined button or key (which may be one on a touch panel) provided as the input device 31 at the specific base station 3 is pressed. At this time, the general radio terminal 5B that is desired to be permitted to utilize the specific base station 3 is placed at a location (e.g., near the specific base station 3) where the general radio terminal 5B can receive radio waves from the specific base station 3.

The CPU 25 of the specific base station 3 senses the trigger (a transmission start instruction), starts a process to transmit a CSG-ID storage instruction (<3A> in FIG. 7A), and initiates a timer T1 and a timer T2 (<3B> in FIG. 7A). The timer T1 counts down for a predetermined period for transmission of a CSG-ID storage instruction. The timer T2 counts down for a predetermined period (an access right information acceptance period) for acceptance of a CSG-ID (access right information) transmitted from the general radio terminal 5B.

Note that the action example illustrated in FIG. 7A illustrates an example in which both of the timer T1 and the timer T2 are initiated by one trigger. This is to reduce the number of operational procedures from an operator of the specific base station 3. Note that the timer T2 (for the start of countdown for the acceptance period) may be initiated (started) by another trigger input from the input device 31 or received from a network that is different from the trigger for the start of transmission of a CSG-ID storage instruction. In other words, the timer T1 and the timer T2 can be configured to start counting down at individual times by individual operations (of entering start instructions).

The transmission processing puts the specific base station 3 into a state to repeat an operation of transmitting The broadcast information A indicating hybrid mode and then transmitting broadcast information including a CSG-ID storage instruction at given intervals (<4> in FIG. 7A). Note that the order of <3B> and <4> may be reversed.

FIG. 8B illustrates an example of the format of broadcast information B used to transmit each of a CSG-ID storage instruction and a CSG-ID deletion instruction. The broadcast information B includes a CSG-ID, one bit (storage bit) indicating whether the broadcast information B is a CSG-ID storage instruction, and one bit (deletion bit) indicating whether the broadcast information B is a CSG-ID deletion instruction. When the storage bit is “1” and the deletion bit is “0,” the broadcast information B indicates a CSG-ID storage instruction. When the storage bit is “0” and the deletion bit is “1,” the broadcast information B indicates a CSG-ID deletion instruction.

Note that the broadcast information B illustrated in FIG. 8B is defined as a new piece of SIB information used in conjunction with the existing broadcast information A in FIG. 8A. Note that, as illustrated in FIG. 8C, broadcast information C into which the broadcast information A illustrated in FIG. 8 and the broadcast information B illustrated in FIG. 8B are integrated may be employed.

Referring back to FIG. 7A, the general radio terminal 5B having received the broadcast information A (hybrid mode) recognizes that the specific base station 3 is in hybrid mode by referring to a CSG/hybrid bit of the broadcast information A. The general radio terminal 5B then becomes ready to refer to and interpret subsequent SIB information. Upon receipt of a piece B of broadcast information (a CSG-ID storage instruction) in this state, the general radio terminal 5B performs a CSG-ID storage process to store a CSG-ID in the CSG-ID storage area 471 (<5> in FIG. 7A).

After storing the CSG-ID, the general radio terminal 5B executes a waiting cell determination process (<6> in FIG. 7A). With the storage of the CSG-ID, the general radio terminal 5B comes to actin the same manner as the specific radio terminal 5A (adds the CSG cell C2 to a list of candidates for a waiting cell). Thus, the general radio terminal 5B can set the CSG cell C2 for the specific base station 3 as a waiting cell, depending on the reception condition of radio waves from the specific base station 3. For example, when a result of a cell search reveals that the signal strength of radio waves from the specific base station 3 is higher than that of radio waves from a cell neighboring the CSG cell C2, the general radio terminal 5B sets the CSG cell C2 as a waiting cell.

When the timer T1 expires, the specific base station 3 finishes the CSG-ID storage instruction transmission process (<7> in FIG. 7A). After that, the specific base station 3 returns to a state to transmit the broadcast information A (CSG mode) (<8> in FIG. 7A).

After determining the CSG cell C2 as a waiting cell, the general radio terminal 5B executes a procedure for radio connection to the specific base station 3 (a radio link establishment procedure (not illustrated)). When a radio link is established, the general radio terminal 5B creates a predetermined message including the CSG-ID and transmits the predetermined message to the specific base station 3 (<9> in FIG. 7A). A predetermined message including a CSG-ID corresponds to a request for permission of connection to a specific base station.

The general radio terminal 5B then initiates a timer T3 (<10> in FIG. 7A). The timer T3 is a timer which counts down for a predetermined period for waiting for a response to a predetermined message (permission request) including a CSG-ID.

When the CPU 25 accepts the predetermined message including the CSG-ID from the general radio terminal 5B before expiration of the timer T2, the timer T2 is stopped at the specific base station 3, and connection of the general radio terminal 5B to the specific base station 3 is permitted (<11>in FIG. 7A). The specific base station 3 transmits a response message corresponding to the predetermined message including the CSG-ID to the general radio terminal 5B (<12> in FIG. 7A). When the general radio terminal 5B receives the response message before expiration of the timer T3, the general radio terminal 5B stops the timer T3 and remains permitted to connect to the specific base station 3.

The sequence in FIG. 7B illustrates a case where a message including a CSG-ID is not accepted by the specific base station 3 before expiration of the timer T2. The processes in <1> to <10> of FIG. 7B are the same as those in FIG. 7A. Note that a predetermined message including a CSG-ID arrives at the specific base station 3 after expiration of the timer T2 in FIG. 7B (<10> in FIG. 7B).

In this case, the CPU 25 of the specific base station 3 refuses to accept the CSG-ID (<11> in FIG. 7B). The refusal to accept the CSG-ID is performed by, for example, rejecting the predetermined message. For this reason, a response message to the predetermined message including the CSG-ID is not transmitted to the general radio terminal 5B.

As a result, the timer T3 expires at the general radio terminal 5B. The CPU 46 of the general radio terminal 5B then deletes the CSG-ID from the CSG-ID storage area 471 (<12> in FIG. 7B). The deletion of the CSG-ID makes the general radio terminal 5B unable to set the CSG cell C2 as a waiting cell. To set a cell other than the CSG cell C2 as a waiting cell, the general radio terminal 5B performs the waiting cell determination process (<13> in FIG. 7B).

Note that the lengths of time periods for which the above-described timers T1, T2, and T3 count down can be set to appropriate values. The length of a time period (a first predetermined period) for the timer T1 is determined in view of a time period within which the desired general radio terminal 5B can receive a piece of broadcast information. The length of a time period (a second predetermined period) for the timer T2 is determined in view of a time period from when the desired general radio terminal 5B stores a CSG-ID to when a predetermined message is accepted by the specific base station 3. The length of a time period (a third predetermined period) for the timer T3 is determined in view of a time period when the predetermined message is transmitted to when a response arrives.

Transmission of a predetermined message including a CSG-ID and reception of a response illustrated in FIG. 7A may be performed in accordance with a new procedure. Alternatively, a CSG-ID may be put in an existing message, and a response to the existing message may double as a response indicating whether the CSG-ID is accepted. For example, a CSG-ID is put in an attach request which is one of existing messages. As for the actions illustrated in FIGS. 7A and 7B, processes to be executed by the CPU 25 of the specific base station 3 and the CPU 46 of the general radio terminal 5B will be described below.

<<CSG-ID Storage Instruction Transmission Process>>

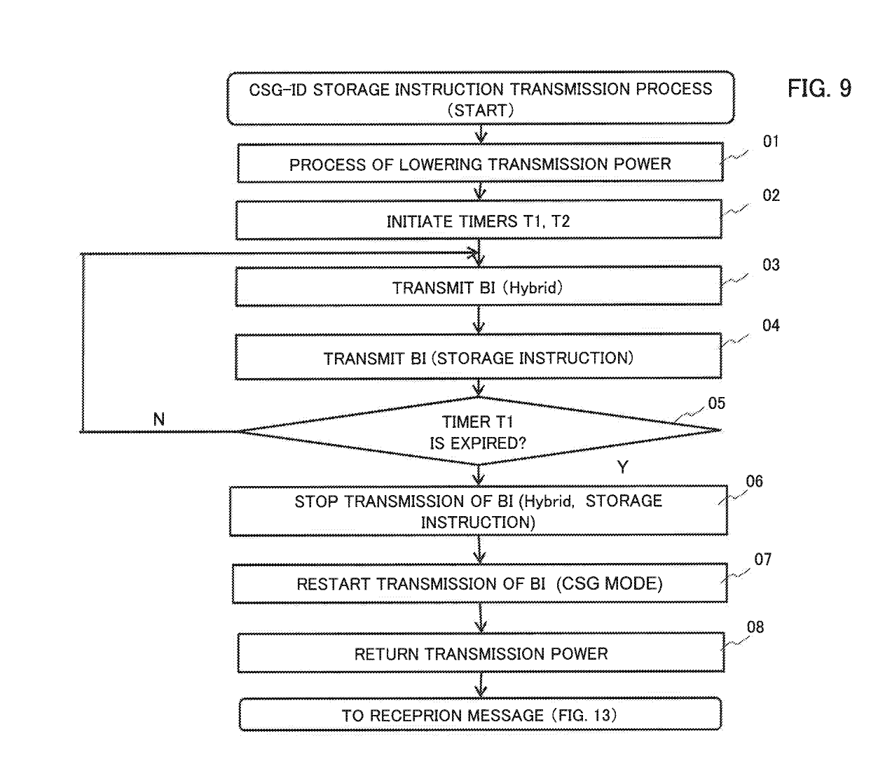

FIG. 9 is a flowchart illustrating an example of the CSG-ID storage instruction transmission process to be executed by the CPU 25 of the specific base station 3. The process illustrated in FIG. 9 is started, for example, when the CPU 25 senses a trigger (start instruction) input from the input device 31. Note that the specific base station 3 is assumed at the start of the process in FIG. 9 to have transmitted a piece A of broadcast information (CSG mode).

In a first process, 01, the CPU 25 performs a process of lowering transmission power for broadcast information. That is, the CPU 25 gives a transmission power lowering instruction to the electric power controlling circuit 33. The electric power controlling circuit 33 lowers transmission power for a piece of broadcast information transmitted from the RF circuit 29. At this time, the transmission power is set to be lower than transmission power at the time of the transmission of the broadcast information A (CSG mode).

Thus, the broadcast information A (hybrid mode) and the broadcast information B (a CSG-ID storage instruction) are transmitted with the transmission power lower than that for the broadcast information A. This makes the propagation distance of the broadcast information A and the broadcast information B shorter than that of the broadcast information A (CSG mode). A range of spread of the broadcast information A (hybrid mode) and the broadcast information B (the CSG-ID storage instruction) is thus narrowed. With this narrowed range of spread, the general radio terminal 5B that is not intended by the manager of the specific base station 3 can be prevented from storing a CSG-ID.

In a next process, 02, the CPU 25 initiates the timer T1 and the timer T2. In a next process, 03, the CPU 25 performs a process of transmitting a piece A of broadcast information (hybrid mode). Subsequently, in a next process, 04, the CPU 25 performs a process of transmitting the broadcast information B (a CSG-ID storage instruction). The processes in 03 and 04 are repeated until the timer T1 expires (05).

When the timer T1 expires (Y in 05), the CPU 25 stops transmitting the broadcast information A (hybrid mode) and the broadcast information B (the CSG-ID storage instruction) (06). The CPU 25 then restarts transmitting the broadcast information A (CSG mode) (07). The CPU 25 gives a transmission power return instruction to the electric power controlling circuit 33, and the electric power controlling circuit 33 returns the transmission power for the piece A of broadcast information (CSG mode) to the original transmission power (08). When the process in 08 is finished, the process advances to a process at the time of message receipt (FIG. 13).

Note that, when the CPU 25 senses a trigger for the end of the transmission process input through operation of the input device 31 before the timer T1 initiated in 02 expires, the process in 06 and subsequent processes may be performed without waiting for expiration of the timer T1. In this case, the period for transmission of a CSG-ID storage instruction can be shortened, and the possibility of a general radio terminal not intended by a manager storing a CSG-ID can be further reduced.

<<CSG-ID Storage Process>>

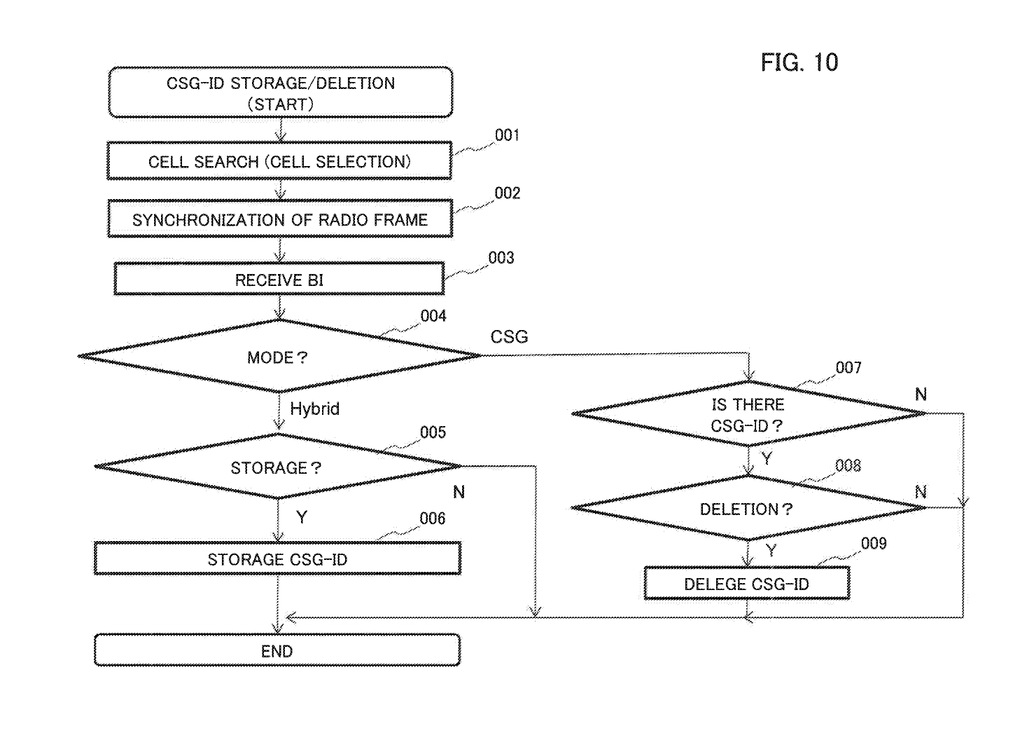

FIG. 10 is a flowchart illustrating an example of the CSG-ID storage process at the general radio terminal 5B. The process is started, for example, with a cell search by the general radio terminal 5B (001). The general radio terminal 5B receives a synchronization signal from the specific base station 3 through the cell search and performs radio frame synchronization (002). With the radio frame synchronization, the general radio terminal 5B becomes able to receive and interpret the broadcast information A from the specific base station 3.

When the broadcast information A from the specific base station 3 is received in a next process, 003, the CPU 46 refers to a CSG/hybrid bit of the broadcast information A and determines whether the mode is CSG mode or hybrid mode (004).

When the mode is hybrid mode (Y in 004), the CPU 46 enters a state to wait for the broadcast information B. Upon receipt of the broadcast information B, the CPU 46 determines whether the broadcast information B is a CSG-ID storage instruction (005).

When the CPU 46 fails to receive the broadcast information B or when the broadcast information B does not indicate a CSG-ID storage instruction (N in 005), the CPU 46 ends the CSG-ID storage process. On the other hand, when receiving the broadcast information B indicating a CSG-ID storage instruction (Y in 005), the CPU 46 stores a CSG-ID included in the broadcast information B in the CSG-ID storage area 471 (hereinafter referred to as the “storage area 471”) (006). After that, the process in FIG. 10 is finished. A CSG-ID deletion process in 007 to 009 illustrated in FIG. 10 will be described later.

Note that information indicating CSG-ID storage may be broadcast (e.g., through display) to the manager of the specific base station 3 by the output device 43 in at least one of a case where a CSG-ID is stored in the storage area 471 and a case where a CSG-ID is deleted from the storage area 471. In this case, the manager of the specific base station 3 may stop the CSG-ID storage instruction transmission process through operation of the input device 31 in the wake of reference to information indicating completion of CSG-ID storage displayed on the output device 43.

<<Waiting cell Determination Process>>

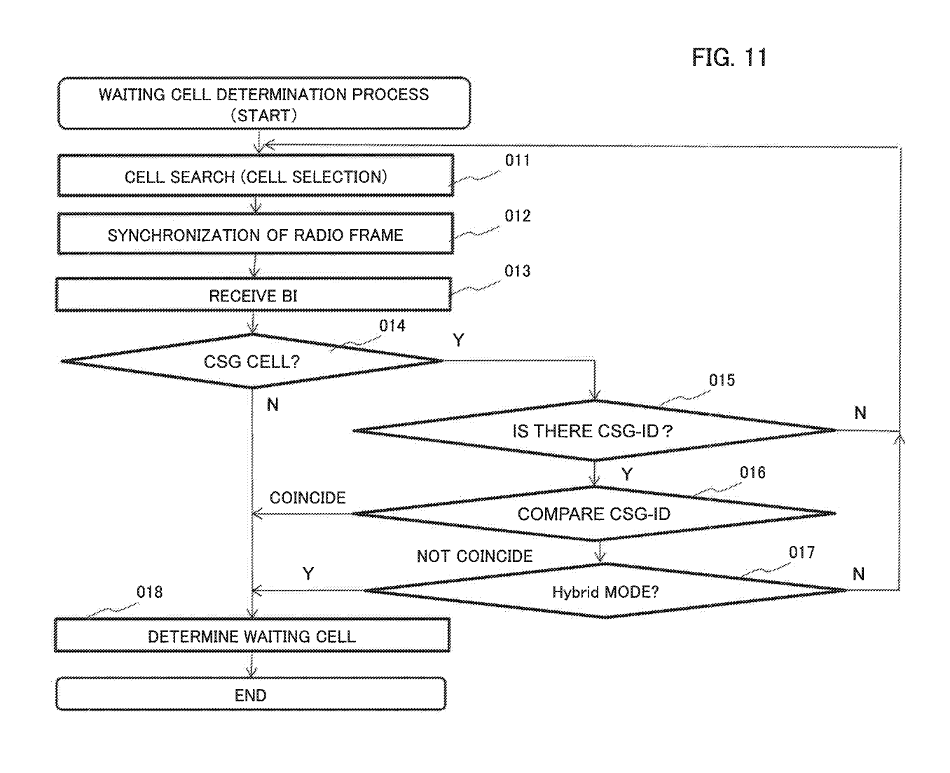

FIG. 11 is a flowchart illustrating an example of the waiting cell determination process to be executed by the CPU 46 of the general radio terminal 5B. The process illustrated in FIG. 11 is started with appropriate timing. For example, when power to the general radio terminal 5B is turned on or when the signal strength of radio waves received from a current waiting cell becomes not more than a predetermined value, the process is started. In the present embodiment, the waiting cell determination process is also started in the wake of storage of a CSG-ID in the storage area 471.

In 011, the CPU 46 performs a cell search to select a base station forming a cell as a candidate for a waiting cell from among one or two or more base stations from which radio waves are received. For example, the CPU 46 determines, as a candidate for a waiting cell, a cell for a base station that high received signal strength is obtained, among the one or two or more base stations.

The general radio terminal 5B desired to utilize the specific base station 3 is placed near the specific base station 3 to receive the broadcast information B (a CSG-ID storage instruction). For this reason, the signal strength of radio waves received from the specific base station 3 becomes higher than that of radio waves received from the neighboring general base station 2. Thus, the CSG cell C2 for the specific base station 3 is selected as a candidate for the waiting cell.

After that, the CPU 46 performs radio frame synchronization with the specific base station 3 (012) and receives apiece of broadcast information from the specific base station 3 (013). The above processes in 011, 012, and 013 are the same as the processes in 01, 02, and 03 illustrated in FIG. 10.

In 014, the CPU 46 having received the broadcast information from the base station of the candidate for the waiting cell determines whether the piece of broadcast information is apiece of broadcast information from a CSG cell. The judgment is made on the basis of whether a CSG-ID is included in the piece of broadcast information.

When the broadcast information is not broadcast information from a CSG cell (when the broadcast information is broadcast information from the general base station 2, N in 014), the CPU 46 determines the macrocell Cl of the general base station 2 as the waiting cell (018) and ends the process in FIG. 11.

On the other hand, when the broadcast information is broadcast information from a CSG cell (Y in 014), the CPU 46 determines whether a CSG-ID is stored in the storage area 471 (015). The CPU 46 then compares a CSG-ID included in the broadcast information with a CSG-ID stored in the storage area 471 to determine whether the two CSG-IDs coincide (016).

When the CSG-IDs coincide (coincide in 016), the process advances to 018, and the CPU 46 determines, as the waiting cell, a base station which has the CSG-ID stored in the storage area 471, i.e., the CSG cell C2 for the specific base station 3 and finishes the process.

On the other hand, when the CSG-IDs do not coincide (not coincide in 016), the CPU 46 determines whether a source of the broadcast information is in hybrid mode (017). When the source is not in hybrid mode (N in 017), the process returns to 011. This is because the base station of the candidate for the waiting cell is a specific base station acting in CSG mode, and another cell needs to be set as the waiting cell. On the other hand, when the source is in hybrid mode (Y in 017), the CPU 46 treats the source of the base station as a macrocell base station (the general base station 2), determines the cell for the source as the waiting cell, and finishes the process.

Note that the CPU 46 may determine a cell for the specific base station 3 as the waiting cell immediately (may skip the processes in 011 to 017 and perform the process in 018) when a CSG-ID is stored in the storage area 471 in the process in FIG. 10.

Note that the process illustrated in FIG. 11 is almost the same as a waiting cell determination process to be executed by the specific radio terminal 5A. For example, the specific radio terminal 5A stores in advance the CSG-ID of a CSG to which the specific radio terminal 5A itself belongs. The specific radio terminal 5A can set the specific base station 3 as awaiting cell by executing the process illustrated in FIG. 11 using the CSG-ID stored in advance.

<<Attach Procedure>>

The general radio terminal 5B having determined the CSG cell C2 for the specific base station 3 as awaiting cell performs a procedure of random access to the specific base station 3 and establishes an RRC (Radio Resource Control) connection (radio link). With this establishment, the general radio terminal 5B is connected by radio to the specific base station 3.

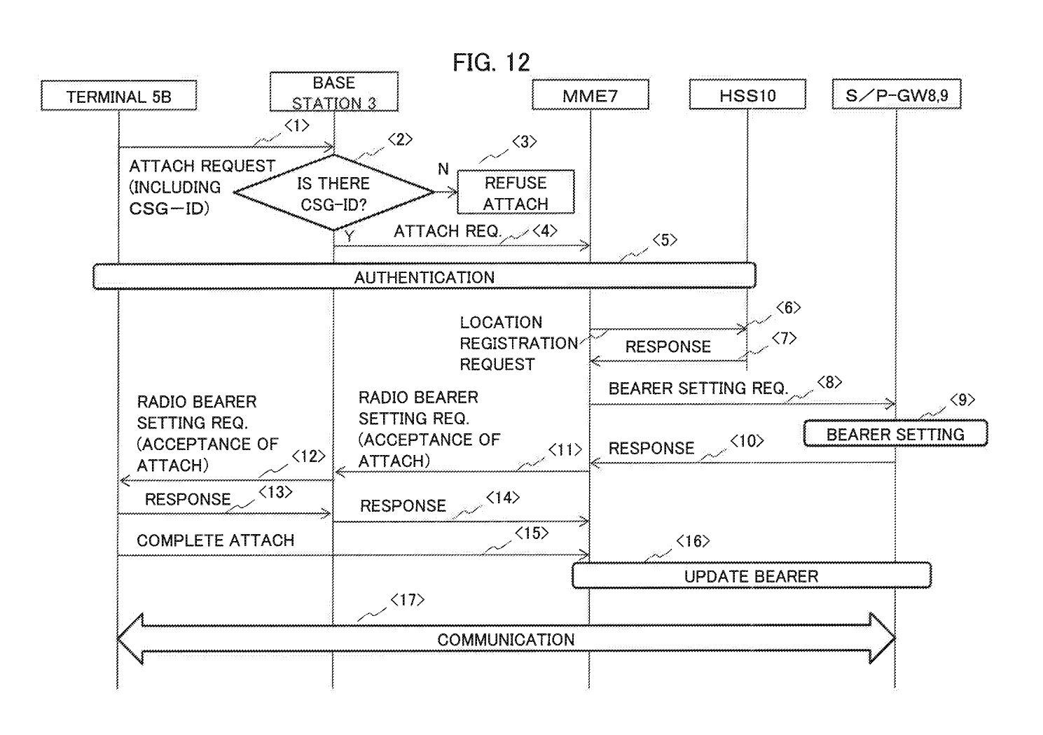

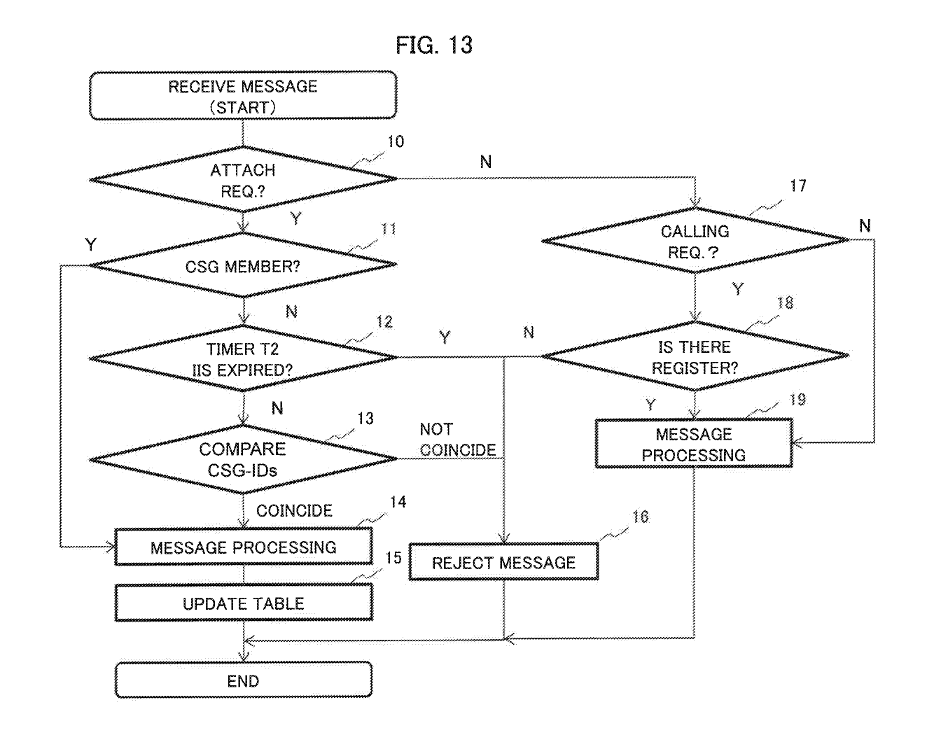

The general radio terminal 5B then performs an attach procedure via the specific base station 3 and registers the location of the general radio terminal 5B in a network. FIG. 12 is a sequence chart illustrating an example of the attach procedure.

In FIG. 12, the general radio terminal 5B transmits an attach request message (ATTACH REQUEST) to the specific base station 3 (<1> in FIG. 12). At this time, the CPU 46 of the general radio terminal 5B generates an attach request including a CSG-ID stored in the storage area 471. In other words, the CPU 46 puts the CSG-ID (access right information) in the attach request (an example of a location registration request). The attach request message is an example of a predetermined message including a CSG-ID.

When an attach request from the radio terminal 5 is received, the CPU 46 of the specific base station 3 determines whether the CSG-ID of the specific base station 3 is included in the attach request (<2> in FIG. 12). When the CSG-ID is not included or when CSG-IDs do not coincide, the CPU 25 abandons the attach request and refuses attachment of the radio terminal 5 (<3> in FIG. 12).

On the other hand, when a CSG-ID included in the attach request coincides with the CSG-ID of the specific base station 3, the CPU 25 performs a process of transferring the attach request to the MME 7 (<4> in FIG. 12). Note that although not illustrated in FIG. 12, the transfer of the attach request is performed when the process in <2> of FIG. 12 is performed before expiration of the timer T2.

FIG. 13 is a flowchart illustrating an example of the process at the time of message receipt at the specific base station 3 and illustrates the details of <2> to <4> in FIG. 12. In FIG. 13, the CPU 25 determines whether a message received from the radio terminal 5 is an attach request (10). When the message is an attach request (Y in 10), the process advances to 11. When the message is not an attach request (N in 10), the process advances to 17.

In 11, the CPU 25 determines whether a terminal ID included in the message (attach request) is registered in the CSG member list 232. When the terminal ID is registered in the CSG member list 232 (Y in 11), the CPU 25 advances the process to 14. When the terminal ID is not registered in the CSG member list 232 (is unregistered) (N in 11), the process advances to 12.

In 12, the CPU 25 determines whether the timer T2 is expired. When the timer T2 is expired (Y in 12), the process advances to 16. When the timer T2 is not expired (N in 12), the process advances to 13.

In 13, the CPU 25 determines whether a CSG-ID included in the attach request matches the CSG-ID (stored in advance in the CF 23) of the specific base station 3. When no CSG-ID is obtained from the attach request or when the CSG-IDs do not coincide (not coincide in 13), the process advances to 16. When the CSG-IDs coincide (coincide in 13), the process advances to 14. With the advancement of the process to 14, the CSG-ID is accepted by the specific base station 3.

In 14, the CPU 25 performs message processing. That is, the CPU 25 performs processing related to the attach request (a process of transferring the attach request to the MME 7). Subsequently, in 15, the CPU 25 performs a process of updating the access right management table 233 (FIG. 4, hereinafter referred to as “table 233”).

When the process advances from 11 to 14 (the source of the attach request is a CSG user), the CPU 25 performs the next update process in 15. That is, the CPU 25 registers the terminal ID of the source of the attach request as a CSG user in the table 233. The CPU 25 also sets an in-cell flag for the terminal ID to on (“1”) (a temporary flag is fixed to off (“0”)). The CPU 25 also stores a time-stamp.

On the other hand, when the process advances from 13 to 14 (the source of the attach request is a temporary user), the CPU 25 performs the next update process in 15. That is, the CPU 25 registers the terminal ID of the source of the attach request as a temporary user in the table 233. The CPU 25 also sets an in-cell flag for the terminal ID to ON (“1”) (a temporary flag is fixed to ON (“1”)). The CPU 25 also stores a time-stamp. When the update of the table 233 is completed, the process in FIG. 13 finishes.

When the process advances from 12 to 16, the CPU 25 rejects (abandons) the attach request (16). That is, the CPU 25 refuses acceptance of the CSG-ID on the grounds of expiration of the timer T2. Since a response to the attach request is not transmitted to the general radio terminal 5B, the general radio terminal 5B is unable to perform location registration via the specific base station 3. The general radio terminal 5B is thus unable to perform communication via the specific base station 3 (communication is not permitted). As described above, connection of the general radio terminal 5B is permitted only if a CSG-ID is accepted within a predetermined period for which the timer T2 counts down.

When the process advances from 13 to 16, the attach request is regarded as an attach request from the radio terminal 5 that does not belong to a CSG for the specific base station 3 and is rejected. When the process in 16 is finished, the process in FIG. 13 finishes.

When the process advances from 10 to 17, the CPU 25 determines whether the message is a call origination request. When the message is a call origination request (Y in 17), the process advances to 18. Otherwise (N in 17), the process advances to 19.

In 18, the CPU 25 determines whether a terminal ID included in the call origination request is registered as a temporary user (with an in-cell flag of “1”) in the table 233. When the terminal ID is not registered (N in 18), the CPU 25 rejects the call origination request (16). With this rejection, communication via the specific base station 3 is prohibited. When the terminal ID is registered (Y in 18), the CPU 25 performs message processing to transfer the call origination request to the MME 7 (19).

When the process advances from 17 to 19, the CPU 25 performs processing corresponding to the message other than an attach request and a call origination request. Note that the specific base station 3 performs the processes indicated by 17 to 19 when the specific base station 3 receives an incoming call signal (paging signal) from the MME 7.

That is, when the message is a paging signal in 17, the CPU 25 determines whether a terminal ID (with an in-cell flag of “1”) corresponding to the paging signal is registered in the table 233 (18). When the terminal ID (with an in-cell flag of “1”) is registered (Y in 18), the CPU 25 transfers the paging signal to the radio terminal 5 (19). When the terminal ID (with an in-cell flag of “1”) is not registered, the CPU 25 rejects the paging signal. With this rejection, arrival of a call at the radio terminal 5 is prohibited.

Note that a time-stamp in the table 233 is updated when a corresponding terminal ID (with an in-cell flag of “1”) is detected at the time of reference to the table 233. When there is an entry (record) with an in-cell flag of “1,” and a predetermined time period is passed since a date and time or a time indicated by a time-stamp of the entry, the CPU 25 sets the in-cell flag of the entry to “0” through, for example, aging processing.

Referring back to FIG. 12, the attach request from the general radio terminal 5B is treated as an attach request from a general radio terminal which is permitted to utilize the specific base station 3 in <2>, and the attach request is transferred to the MME 7 (<4> in FIG. 12).

The MME 7 receiving the attach request obtains authentication information from the HSS 10 and performs authentication of the general radio terminal 5B (a user) (<5>in FIG. 12). The MME 7 transmits a location registration request for the general radio terminal 5B to the HSS 10 (<6>in FIG. 12). The HSS 10 performs location registration of the general radio terminal 5B in response to the location registration request and sends a response message (location registration completion message) to the location registration request to the MME 7 (<7> in FIG. 12). With this location registration, the general radio terminal 5B normally enters a state in the CSG cell C2.

The MME 7 selects the S-GW 8 and the P-GW 9 as bearer setting destinations on the basis of an APN (Access Point Name), of which the MME 7 is notified by the general radio terminal 5B, and transmits a bearer setting request to the selected S-GW 8 (<8> in FIG. 12). The S-GW 8 sets a bearer between the S-GW 8 and the P-GW 9 (<9> in FIG. 12). When the bearer setting is completed, the S-GW 8 transmits a response message (including apiece of transmission information intended for abase station) indicating bear setting completion to the MME 7 (<10> in FIG. 12).

The MME 7 transmits the piece of transmission information from the S-GW 8 as a radio bearer setting request (<11> in FIG. 12). The radio bearer setting request includes an attach acceptance signal. The specific base station 3 sets a radio bearer between the specific base station 3 and the general radio terminal 5B in response to the radio bearer setting request and transmits the attach acceptance signal to the general radio terminal 5B (<12> in FIG. 12). The attach acceptance signal is a response message to the attach request and corresponds to the response illustrated in <12> in FIG. 7A. The general radio terminal 5B can remain permitted to connect to the specific base station 3 by receiving an attach acceptance signal before the timer T3 expires.

The specific base station 3 receives a radio bearer setting response message from the general radio terminal 5B (<13> in FIG. 12) and transmits a piece of transmission information intended for the S-GW 8 in the message to the MME (<14> in FIG. 12).

Upon receipt of an attach completion message from the general radio terminal 5B (<15> in FIG. 12), the MME 7 sends a piece of transmission information intended for the S-GW 8 to the S-GW 8. The S-GW 8 sets a bearer between the specific base station 3 and the S-GW 8 (<16> in FIG. 12). With this setting, bearer setting between the general radio terminal 5B and the specific base station 3, bearer setting between the specific base station 3 and the S-GW 8, and bearer setting between the S-GW 8 and the P-GW 9 are completed. In the above-described manner, transmission and reception of user data between the general radio terminal 5B and the P-GW 9 (the external network 4) via the specific base station 3 becomes possible, i.e., the general radio terminal 5B becomes able to execute communication via the specific base station 3 (<17> in FIG. 12).

That is, the general radio terminal 5B can send a calling request message to the MME 7 and can establish a call to a communication partner (e.g., a terminal connected to the external network 4). Alternatively, when a call to the general radio terminal 5B is originated by a given terminal, the MME 7 transmits a paging signal to the specific base station 3, and the specific base station 3 transfers the paging signal to the general radio terminal 5B, which allows the general radio terminal 5B to perform call termination processing.

<<CSG-ID Deletion Process>>

Through the above-described action, the general radio terminal 5B can perform communication utilizing the specific base station 3 acting in CSG mode on the conditions that the general radio terminal 5B stores a CSG-ID and that the CSG-ID is accepted by the specific base station 3 before the timer T2 expires.

However, after communication ends, the specific base station 3 is no longer needed by an owner of the general radio terminal 5B. For this reason, with CSG-ID deletion processes to be described below, a CSG-ID is deleted from the storage area 471, and the general radio terminal 5B is returned to its original state. In addition to the deletion processes described below, the CPU 25 may delete a CSG-ID after a predetermined time period passes since storage of the CSG-ID.

[First Deletion Process]

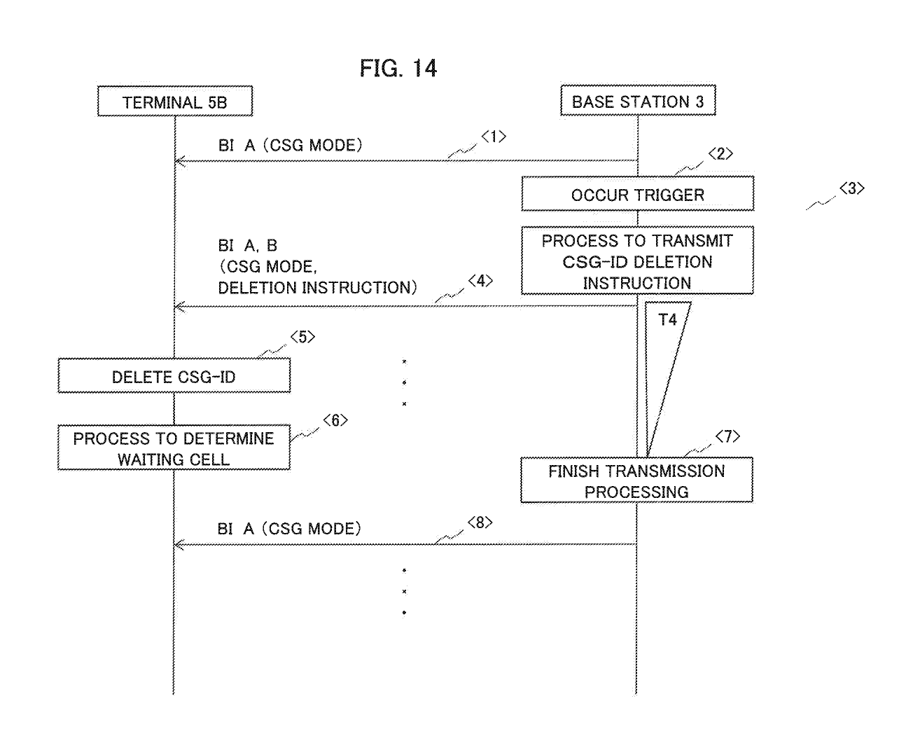

FIG. 14 is a sequence chart illustrating action at the time of CSG-ID deletion. In a state in which the specific base station 3 is acting in CSG mode (<1> in FIG. 14), a trigger for CSG-ID deletion is generated (<2> in FIG. 14). The CPU 25 of the specific base station 3 then starts a process of transmitting a CSG-ID deletion instruction (<3> in FIG. 14).

In the transmission process, the CPU 25 of the specific base station 3 places the specific base station 3 in a state to periodically transmit a piece A of broadcast information (CSG mode) and a piece B of broadcast information (a CSG-ID deletion instruction) (<4> in FIG. 14). Upon receipt of a CSG-ID deletion instruction, the general radio terminal 5B deletes a corresponding CSG-ID from the storage area 471 (<5>in FIG. 14).

Through the waiting cell determination process (FIG. 11) performed by the general radio terminal 5B in the wake of CSG-ID deletion or a synchronously with CSG-ID deletion, a waiting cell is changed from the CSG cell C2 for the specific base station 3 to another cell (<6> in FIG. 14). At the specific base station 3, count-down of a timer T4 (for a fourth predetermined period) is started simultaneously with the start of the deletion instruction transmission process. When the timer T4 expires, the CPU 25 ends the deletion instruction transmission process (<7> in FIG. 14) and stops transmitting a piece B of broadcast information (a CSG-ID deletion instruction) (<8> in FIG. 14).

The details of a CSG-ID deletion process (a first deletion process) at the general radio terminal 5B will be described. As illustrated in FIG. 10, upon receipt of a piece A of broadcast information (CSG mode) from the specific base station 3 (CSG in 004), the CPU 46 of the general radio terminal 5B determines whether a CSG-ID is stored in the storage area 471 (007).

When no CSG-ID is stored in the storage area 471 (N in 007), the process in FIG. 10 ends. When a CSG-ID is stored in the storage area 471 (Y in 007), the CPU 46 determines whether apiece B of broadcast information received subsequently to the piece A of broadcast information indicates a CSG-ID deletion instruction (008).

When the CPU 46 fails to sense a piece B of broadcast information or when the piece B of broadcast information does not indicate a CSG-ID deletion instruction (N in 008), the process in FIG. 10 ends. On the other hand, when the CPU 46 senses a CSG-ID deletion instruction (Y in 008), the CPU 46 deletes the CSG-ID from the storage area 471 (009) and ends the process in FIG. 10.

In the subsequent waiting cell determination process (FIG. 11), the general radio terminal 5B stores no CSG-ID. The CSG cell C2 for the specific base station 3 is ruled out as a candidate for the waiting cell (N in 015), and another cell is determined as the waiting cell.

[Second Deletion Process]

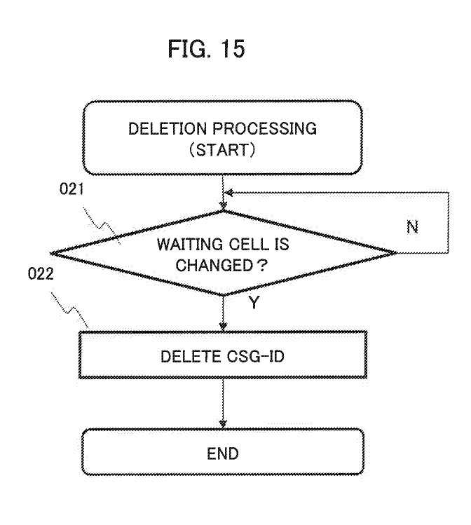

FIG. 15 is a flowchart illustrating a process example of a second CSG-ID deletion process (second deletion process). The second deletion process can be executed instead of or in addition to the first deletion process illustrated in FIG. 10.

In FIG. 15, the CPU 46 watches for a change of the waiting cell, for example, in the wake of determination of the CSG cell C2 for the specific base station 3 as a waiting cell (021). When the waiting cell is changed (Y in 021), the CPU 46 deletes a CSG-ID from the storage area 471 (022) and ends the process.

The change of the waiting cell means that the signal strength of radio waves received from the specific base station 3 at the general radio terminal 5B becomes lower than that of radio waves received from a neighboring base station or that the general radio terminal 5B is so separated that the general radio terminal 5B is unable to receive radio waves from the specific base station 3. In this case, the specific base station 3 is considered to be no longer needed by the general radio terminal 5B. For this reason, the CPU 46 deletes the CSG-ID in the wake of the change of the waiting cell.

[Third Deletion Process]

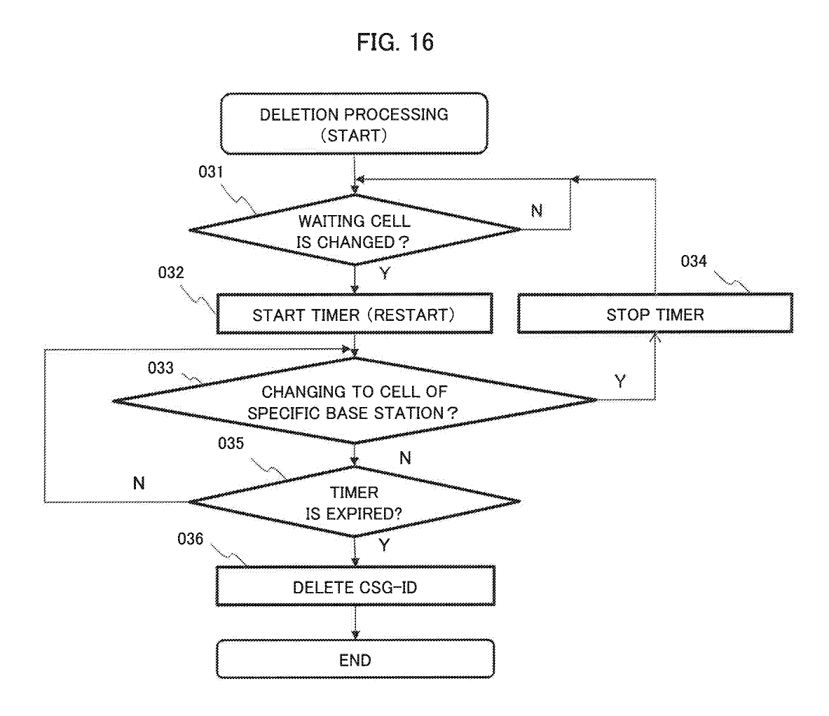

FIG. 16 is a flowchart illustrating a process example of a third CSG-ID deletion process (third deletion process). The third deletion process can be executed instead of or in addition to the first deletion process illustrated in FIG. 10. The third deletion process is executed as a result of a choice between the third deletion process and the second deletion process.

In FIG. 16, the CPU 46 starts watching for a change of a waiting cell, for example, in the wake of determination of the CSG cell C2 for the specific base station 3 as the waiting cell (031). When the waiting cell is changed (Y in 031), the CPU 46 starts count-down of a timer (032).

After that, the CPU 46 waits for a change of the waiting cell to the CSG cell C2 for the specific base station 3 before the timer expires (033 and 035). If the waiting cell is changed to the CSG cell C2 before expiration of the timer (Y in 033), the CPU 46 stops the timer (034) and returns the process to 031.

On the other hand, when the timer is expired (Y in 035), the CPU 25 deletes a CSG-ID from the storage area 471 (036) and finishes the process. As described above, according to the third method, a stored state of the CSG-ID is maintained when the general radio terminal 5B leaves temporarily from the neighborhood of the specific base station 3 and returns before the timer expires. This saves the trouble of storing a CSG-ID again after temporary separation from the CSG cell C2. Note that, in this case, an operation of entering a start instruction for starting count-down of the timer T2 at the specific base station 3 in order to make the general radio terminal 5B enter the cell for the specific base station 3 again.

[Fourth Deletion Process]

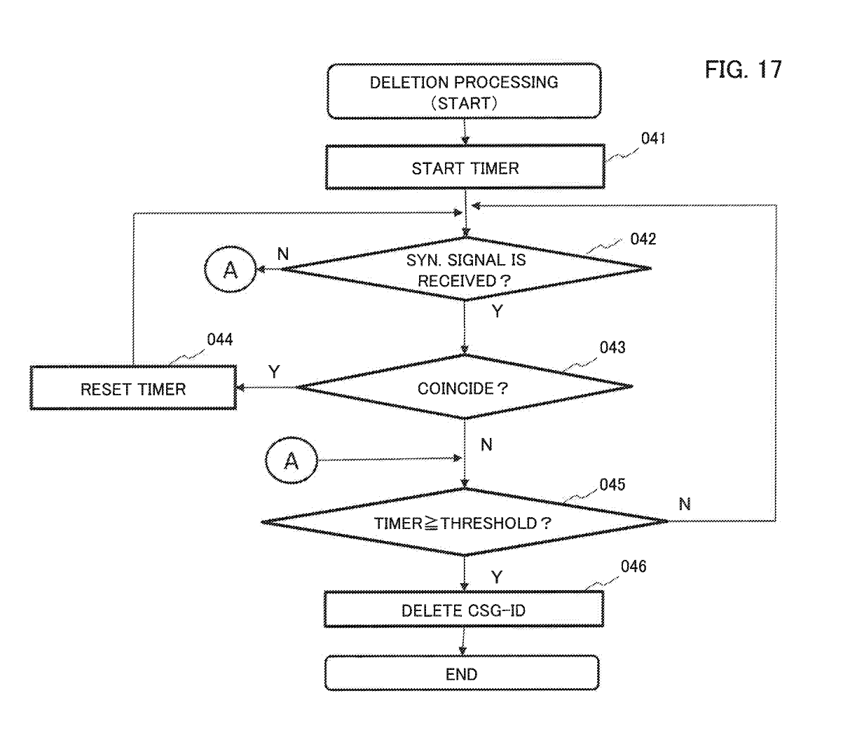

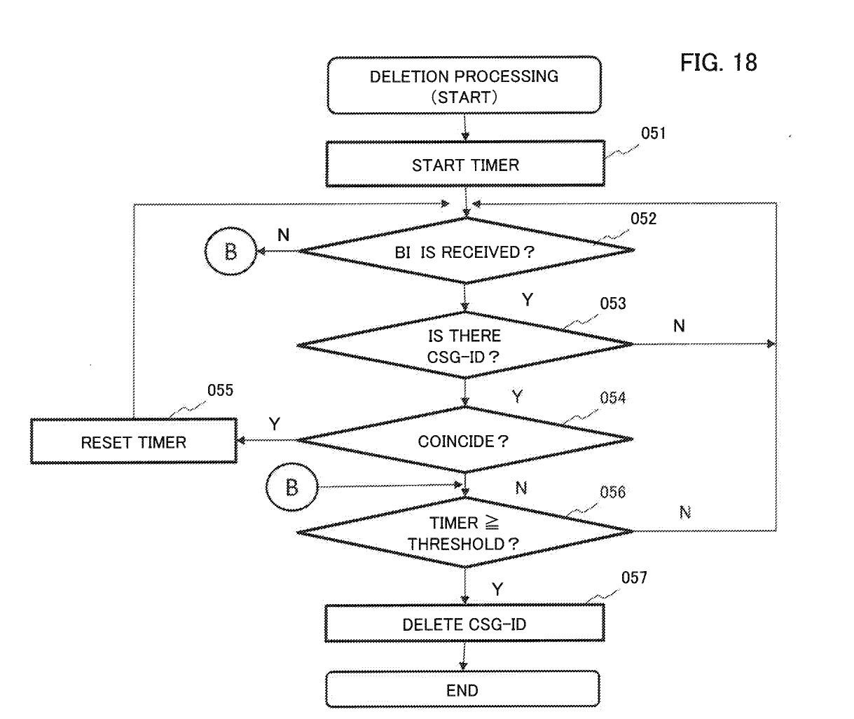

FIG. 17 is a flowchart illustrating a process example of a fourth CSG-ID deletion process (fourth deletion process). The fourth deletion process can be employed alone or in combination with at least one of the first to third deletion processes.

The fourth deletion process is based on the assumption that the CPU 46 of the general radio terminal 5B stores the physical cell ID (PCI) of the specific base station 3 in advance in the memory 47. The PCI can be obtained in the course of processing a synchronization signal from the specific base station 3.

In FIG. 17, the CPU 46 initiates a timer (041) and then performs a process of receiving a synchronization signal (042). When a PCI (cell ID) obtained from the synchronization signal coincides with the PCI of the specific base station 3 stored in advance (Y in 043), the CPU 46 resets the timer (044) and returns the process to 042. The obtainability of the PCI of the specific base station 3 from the synchronization signal means that the general radio terminal 5B is present at a location where communication via the specific base station 3 is executable.

On the other hand, when the CPU 46 is unable to obtain the PCI of the specific base station 3 until a timer value becomes not less than (exceeds) a predetermined threshold (Y in 045), the CPU 46 deletes a CSG-ID from the storage area 471 (046). This is because the general radio terminal 5B is considered to have moved to a location where the general radio terminal 5B is unable to receive radio waves (a synchronization signal) from the specific base station 3.

[Fifth Deletion Process]

FIG. 18 is a flowchart illustrating a process example of a fifth CSG-ID deletion process (fifth deletion process). In FIG. 18, the CPU 46 initiates a timer (051) and then performs a process of receiving a piece of broadcast information (052). When a CSG-ID obtained from the piece of broadcast information matches the CSG-ID of the specific base station 3 stored in the storage area 471 (Y in 053 and Y in 054), the CPU 46 resets the timer and returns the process to 052. The obtainability of the CSG-ID of the specific base station 3 from the piece of broadcast information means that the general radio terminal 5B is present at a location where communication via the specific base station 3 is executable.

On the other hand, when the CPU 46 is unable to obtain the CSG-ID of the specific base station 3 until a timer value becomes not less than (exceeds) a predetermined threshold (Y in 056), the CPU 46 deletes the CSG-ID from the storage area 471 (057). This is because the general radio terminal 5B is considered to have moved to a location where the general radio terminal 5B is unable to receive radio waves (a piece of broadcast information) from the specific base station 3.

The fifth deletion process is executed as a result of a choice between the fifth deletion process and the fourth deletion process. In the fourth and fifth deletion processes, the CPU 46 monitors radio waves from the specific base station 3 and, when a state in which sensing of radio waves from the specific base station 3 is impossible continues for a predetermined period, deletes the CSG-ID. Note that the fifth deletion process can be altered into a process of storing a CGI (cell ID) for a specific base station in advance and detecting a CGI from a piece of broadcast information to compare the CGIs.

### Effects of First Embodiment

According to the first embodiment, connection to (utilization of) the specific base station 3 by the general radio terminal 5B is permitted only if a CSG-ID is accepted during a predetermined period for which the timer T2 initiated upon receipt of a start instruction counts down. Since a period for which connection of the general radio terminal 5B to the specific base station 3 is permitted is limited to the predetermined period for the timer T2, the number of connections of the general radio terminals 5B to the specific base station 3 can be curbed.

In the first embodiment, a CSG-ID storage instruction is transmitted using a piece B of broadcast information. This configuration allows delivery and receipt of a CSG-ID between an existing radio terminal and a base station using the hardware configurations of the existing radio terminal and the base station.

In the first embodiment, since a CSG-ID storage instruction is transmitted in hybrid mode, transmission power is lowered. This allows curbing of the extent of spread of a storage instruction.

In the first embodiment, a CSG-ID stored in the general radio terminal 5B can be deleted by the various deletion methods (deletion processes) described above. This allows deletion of an unnecessary CSG-ID. The second to fifth deletion processes allow automatic deletion of a CSG-ID.

### Second Embodiment

A second embodiment will be described. The second embodiment has similarities to the first embodiment. Differences will be mainly described, and a description of the similarities will be omitted. The first embodiment has described a configuration in which an unnecessary CSG-ID is deleted from the general radio terminal 5B. The second embodiment will describe a configuration in which utilization of a specific base station 3 (a CSG cell C2) by a general radio terminal 5B can be limited while a CSG-ID stored in a storage area 471 is maintained.

The hardware configurations of the general radio terminal 5B and the specific base station 3 and processing by a CPU 25 and a CPU 46 in the second embodiment are the same as those in the first embodiment (FIGS. 2 and 5), and a description thereof will be omitted. Additionally, processing and action related to storage of a CSG-ID (access right information) of the general radio terminal 5B and checking of a CSG-ID in a message at the specific base station 3 (FIG. 13) in the second embodiment are also the same as in the first embodiment, and a description thereof will be omitted.

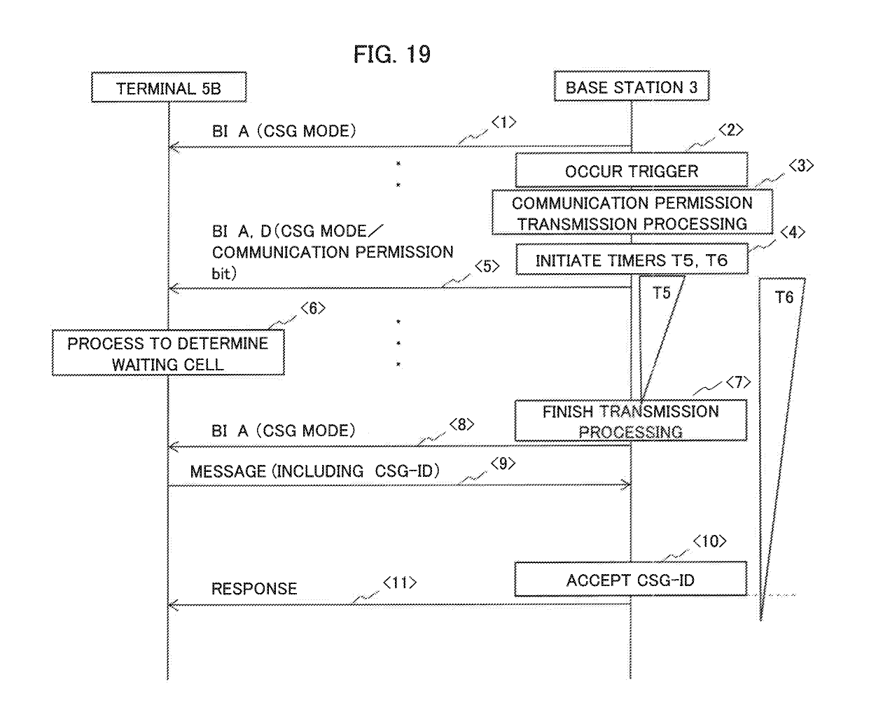

FIG. 19 is a sequence chart illustrating an example of action according to the second embodiment. The sequence in FIG. 19 is based on the assumption that the general radio terminal 5B storing a CSG-ID is located in the neighborhood of the CSG cell C2 and is in a radio-wave reception environment where the CSG cell C2 can be made a candidate for a waiting cell.

At the start of the sequence in FIG. 19, the specific base station 3 transmits the broadcast information A (CSG mode) (<1> in FIG. 19). In this state, when a trigger for the start of transmission of a communication permission bit is generated (<2> in FIG. 19), the CPU 25 starts a communication permission transmission process (<3> in FIG. 19). For example, input of a start instruction from an input device 31 serves as the trigger. Note that automatic trigger generation through setting of a timer may be adopted.

When the transmission process is started, the CPU 25 initiates a timer T5 and a timer T6 (<4> in FIG. 19). The timer T6 counts down for a predetermined period (a fifth predetermined period) for transmission of a communication permission bit. The timer T6 counts down for a predetermined period (a sixth predetermined period) for acceptance of a CSG-ID transmitted from the general radio terminal 5B having received a communication permission bit.

The CPU 25 performs communication permission bit transmission processing to alternately transmit the broadcast information A indicating CSG mode (FIG. 8A) and a piece of broadcast information indicating permission for communication (broadcast information D) (<5> in FIG. 19).

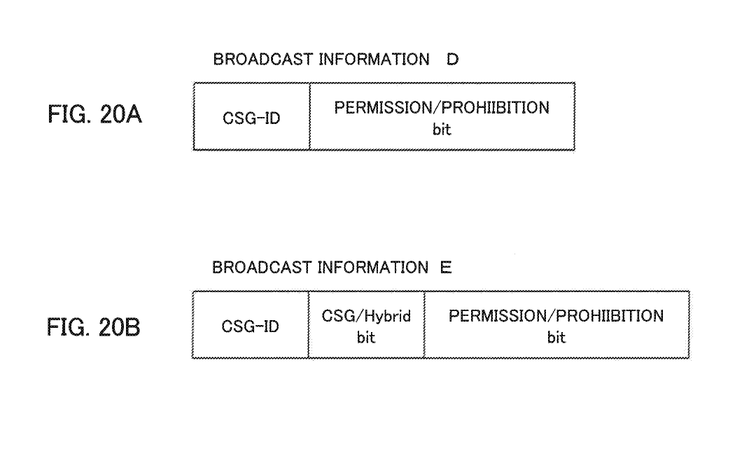

FIG. 20A illustrates an example of a format of broadcast information indicating permission for communication (broadcast information D). The broadcast information D includes a CSG-ID and a permission/prohibition bit (communication permission bit). A permission/prohibition bit of “0” indicates “prohibition of communication” while a permission/prohibition bit of “1” indicates “permission for communication.” Broadcast information E (FIG. 20B) into which the broadcast information A and the broadcast information D are integrated may be employed instead of the broadcast information D.

When the broadcast information A (CSG mode) and the broadcast information D are sensed in a waiting cell determination process (<6> in FIG. 19), the CPU 46 of the general radio terminal 5B determines the CSG cell C2 for the specific base station 3 as a waiting cell.

When the timer T5 is expired, the CPU 25 of the specific base station 3 finishes the communication permission transmission process (<7> in FIG. 19) and stops transmission of the broadcast information D (the specific base station 3 enters a state to transmit the broadcast information A (CSG mode) (<8> in FIG. 19). Note that transmission of the broadcast information D may be stopped by input through operation of the input device 31 as well as control using the timer T5, instead of using the timer T5.

The general radio terminal 5B determining the CSG cell C2 as the waiting cell transmits a predetermined message including a CSG-ID (<9> in FIG. 19). After that, when the CSG-ID is accepted by the specific base station 3 (<10> in FIG. 19) before the timer T6 expires, connection of the general radio terminal 5B to the specific base station 3 is permitted. When a response message is received by the general radio terminal 5B (<11> in FIG. 19), the general radio terminal 5B can perform communication using the specific base station 3. The predetermined message may be a unique message or an attach request in which a CSG-ID is put.

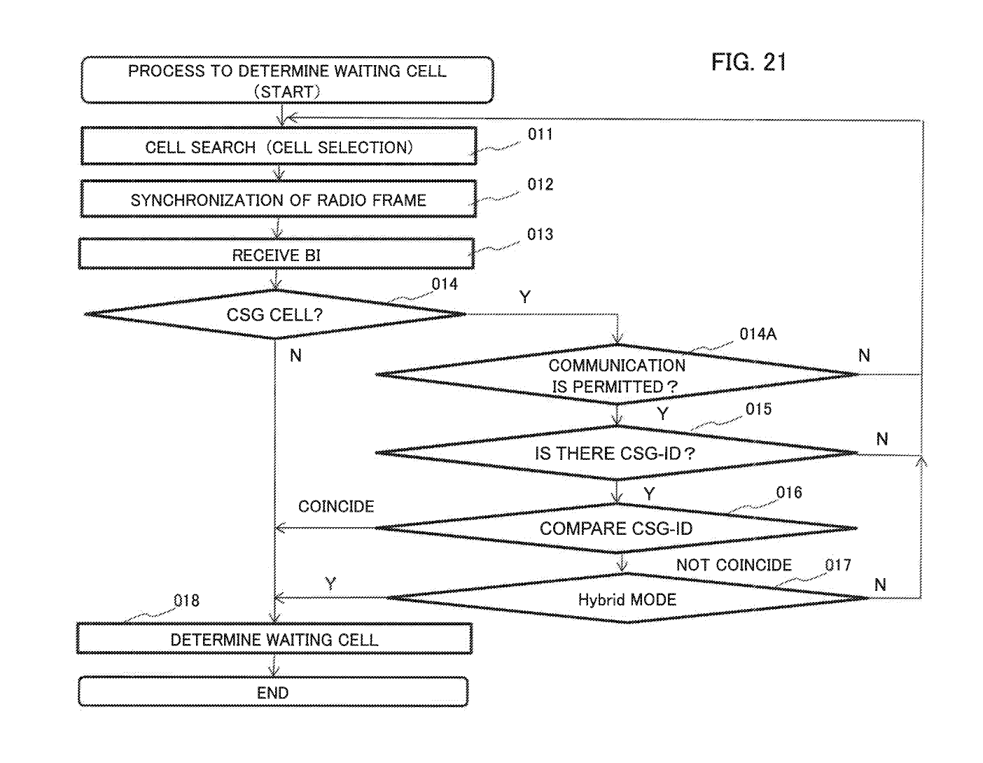

FIG. 21 is a flowchart illustrating an example of the waiting cell determination process according to the second embodiment. The process illustrated in FIG. 21 is different from the waiting cell determination process according to the first embodiment in the point below. A process in 014A is inserted between 014 and 015. The other processes (processes in 011 to 014 and 015 to 018) are the same as those in the first embodiment, and a description thereof will be omitted.

When the broadcast information D with a permission/prohibition bit of “1” (permission for communication) is received in 014A (Y in 014A), the CPU 46 advances the process to 015. Thus, the general radio terminal 5B can perform communication using the specific base station 3 on the additional condition that broadcast information indicating permission for communication is being transmitted.

On the other hand, when the broadcast information D is not received in 014A or the value of a permission/prohibition bit is “0” (prohibition of communication) (N in 014A), the process is returned to 011. Thus, in a state in which (during a period when) the broadcast information D (permission for communication) is not broadcast, communication using the specific base station 3 is not permitted even if the general radio terminal 5B stores a CSG-ID.

According to the second embodiment, connection to the specific base station 3 is permitted when a CSG-ID is accepted by the specific base station 3 before expiration of a predetermined period for which the timer T6 that is initiated after receipt of an instruction to start the communication permission transmission process counts down. With this configuration, a manager of the specific base station 3 can adjust a period for which the specific base station 3 is open to the general radio terminal 5B storing a CSG-ID (access right information). Thus, in the second embodiment, processing related to CSG-ID deletion is unnecessary. This eliminates the need to provide a CSG-ID to the given general radio terminal 5B again.

### Third Embodiment

A third embodiment will be described. The third embodiment has similarities to the first embodiment. Differences will be mainly described, and a description of the similarities will be omitted. The first embodiment is described a configuration in which a CSG-ID (access right information) is transmitted (publicized) as apiece of broadcast information to the general radio terminal 5B. The third embodiment will describe a configuration in which a CSG-ID (access right information) is supplied to a general radio terminal 5B by a transmission method other than a piece of broadcast information.

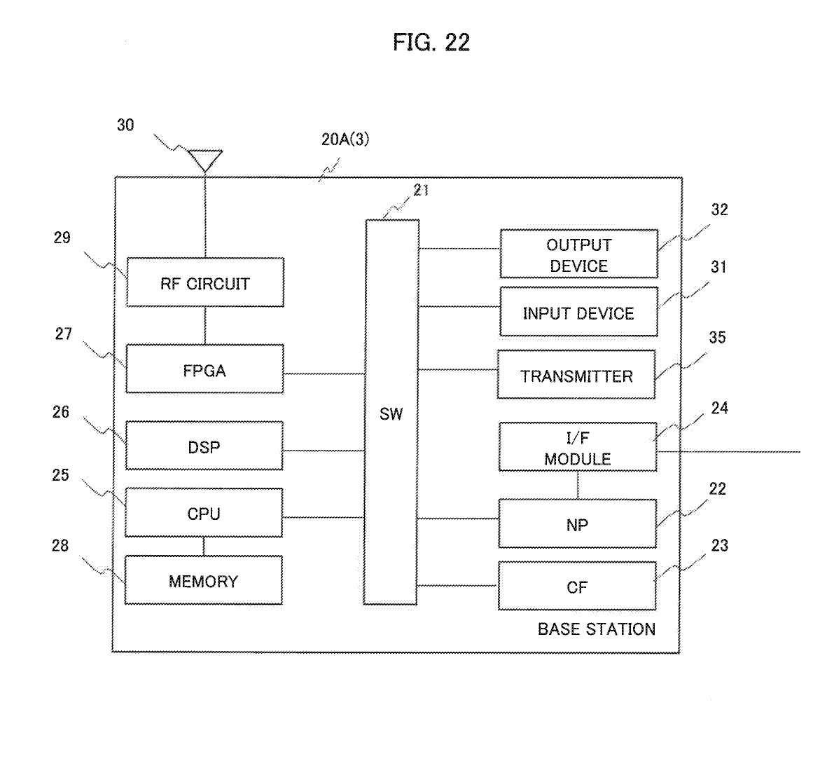

FIG. 22 illustrates an example of the configuration of abase station 20A which can be employed as the specific base station 3 according to the third embodiment. The base station 20A is different from the base station 20 (FIG. 2) according to the first embodiment in that the base station 20A further includes a transmitter (Tx) 35. The base station 20A is also different in that the base station 20A need not have an electric power controlling circuit 33.

The transmitter 35 is communication equipment for near field radio communication (non-contact communication) and is communication equipment conforming to any one of various standards, such as NFC, Bluetooth (registered trademark), UWB (Ultra-Wide Band), Wi-Fi, Transfer jet, and RFID. The transmitter 35 maybe a transmitter for infrared communication.

The third embodiment will describe an example in which the transmitter 35 is an IC card conforming to NFC. The IC card has an IC chip and a memory, and a CSG-ID (access right information) is stored in advance in the memory. The IC card may be detachable from a main body of the base station 20A.

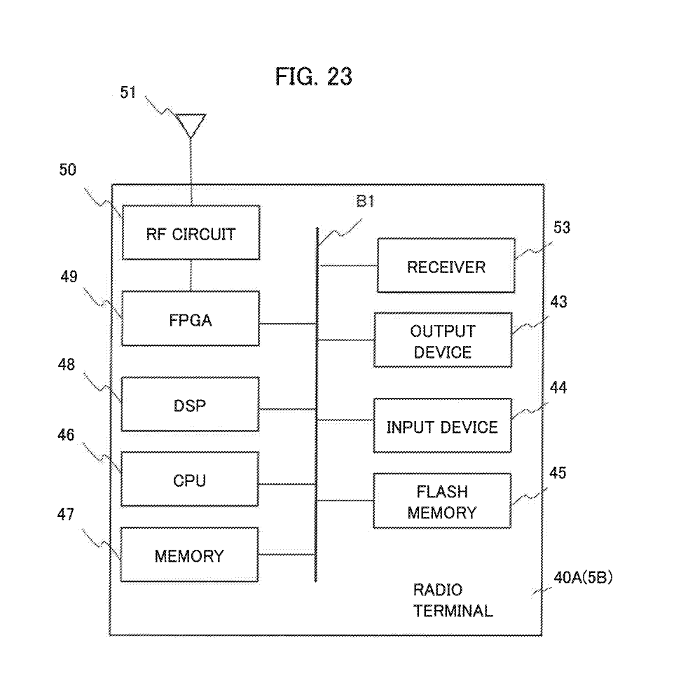

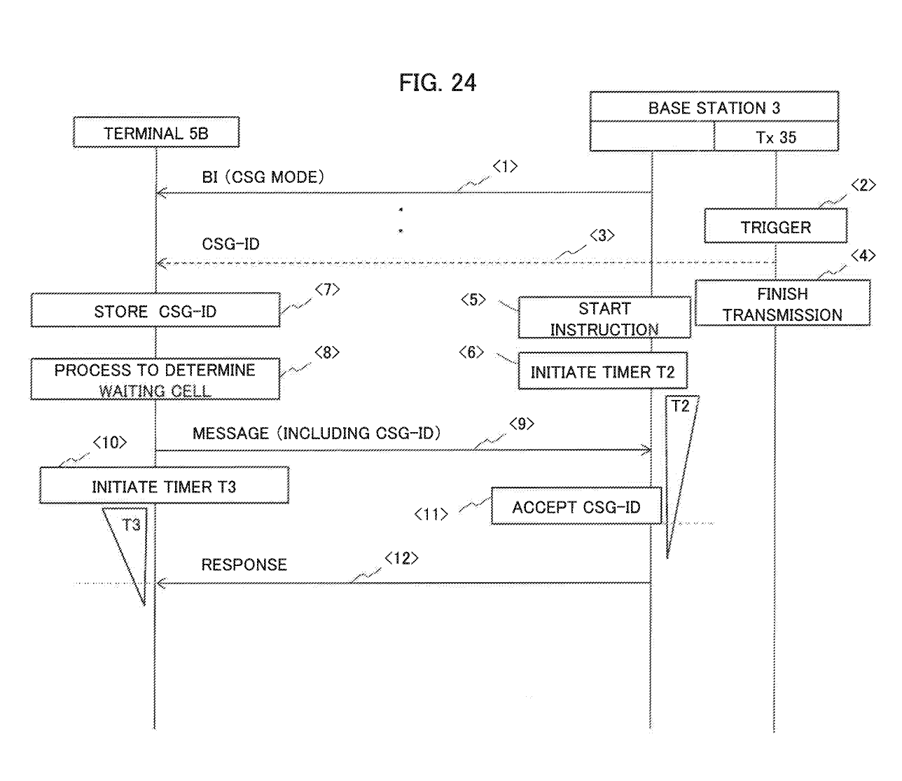

FIG. 23 illustrates an example of the configuration of a radio terminal 40A which can be employed as the general radio terminal 5B according to the third embodiment. The radio terminal 40A is different from the radio terminal 40 (FIG. 5) according to the first embodiment in that the radio terminal 40A further includes a receiver (Rx) 53.

The receiver 53 is a receiver that deals with the transmitter 35, which the base station 20A (the specific base station 3) includes, and is communication equipment for near field radio communication (non-contact communication) or infrared communication. In the third embodiment, the receiver 53 is communication equipment which acts as a reader/writer that deals with the transmitter 35 (an IC card conforming to NFC). The receiver 53 receives a CSG-ID transmitted from the transmitter 35 (the IC card) when the distance to the transmitter 35 (the IC card) becomes shorter than a predetermined distance. The received CSG-ID is stored in a storage area 471 by the receiver 53 or a CPU 46.

FIG. 24 is a sequence chart illustrating an example of action when the general radio terminal 5B sets a CSG cell C2 for the specific base station 3 as a waiting cell according to the third embodiment. In the third embodiment, the specific base station 3 does not switch from CSG mode to hybrid mode and always broadcasts a piece A of broadcast information (CSG mode) (<1> in FIG. 24).

When the general radio terminal 5B that is desired to connect to the specific base station 3 is brought close to the specific base station 3 (the transmitter 35 (the IC card)), and the distance between the transmitter 35 and the receiver 53 reaches a distance which allows near field radio communication, a trigger for transmission of a CSG-ID is generated at the transmitter 35 (<2> in FIG. 24), and the transmitter 35 transmits a CSG-ID to the receiver 53 (<3> in FIG. 24). The transmission ends in a predetermined period (<4> in FIG. 24).

An operator (manager) of the specific base station 3 then enters a start instruction through an input device 31 (<5> in FIG. 24). A CPU 25 of the specific base station 3 initiates a timer T2 (<6> in FIG. 24) and is ready to accept a CSG-ID until the timer T2 expires.

On the other hand, in the general radio terminal 5B, a CSG-ID received by the receiver 53 is passed to the CPU 46, and the CPU 46 stores the CSG-ID in the storage area 471 (<7>in FIG. 24). At this time, the receiver 53 may store the CSG-ID in the storage area 471.

When the CSG-ID is stored, the CPU 46 of the general radio terminal 5B executes a waiting cell determination process similar to that in the first embodiment (<8> in FIG. 24). In the waiting cell determination process, a CSG cell is determined as a waiting cell. Actions in <9> to <12> of FIG. 24 after that are the same as the actions (in <9> to <12> of FIG. 7A) in the first embodiment. That is, when a CSG-ID is accepted by the specific base station 3 before the timer T2 expires (<11> in FIG. 24), connection to the specific base station 3 by the general radio terminal 5B is permitted.

In the third embodiment, any one of the CSG-ID deletion processes described in the first embodiment can be employed for a CSG-ID stored in the general radio terminal 5B. Alternatively, the configuration (transmission of a permission/prohibition bit) described in the second embodiment may be employed.

As described above, in the third embodiment, delivery and receipt of a CSG-ID is performed using near field radio communication or infrared communication, instead of delivery and receipt using apiece of broadcast information. This allows the specific base station 3 to be prevented from switching to hybrid mode and allows the unexpected general radio terminal 5B to be prevented from storing a CSG-ID.

In the third embodiment, an IC card conforming to NFC is employed as an example. Delivery and receipt of a CSG-ID is performed by bringing the general radio terminal 5B close to the specific base station 3 (the transmitter 35) (holding the general radio terminal 5B over the specific base station 3 or bringing the general radio terminal 5B into contact with the specific base station 3). As described above, in the third embodiment, radio communication is performed over a radio wave propagation distance shorter than that for apiece of broadcast information, which allows a CSG-ID to be prevented from spreading. Additionally, the need for operation of the specific base station 3 or the general radio terminal 5B at the time of delivery and receipt of a CSG-ID can be eliminated. Since communication is based on a standard different from the standard for transmission of a piece of broadcast information, the possibility of storage of a CSG-ID by the unexpected general radio terminal 5B can be made lower than the case of a piece of broadcast information.

The IC card (the transmitter 35) can be used in a state separate from the main body of the specific base station 3. Depending on the installation location of the specific base station 3, bringing the general radio terminal 5B close may be difficult or guiding an owner of the general radio terminal 5B to the installation site of the specific base station 3 may be embarrassing. In this case, a CSG-ID can be stored in the general radio terminal 5B by bringing the IC card separated from the specific base station 3 into contact with the general radio terminal 5B.

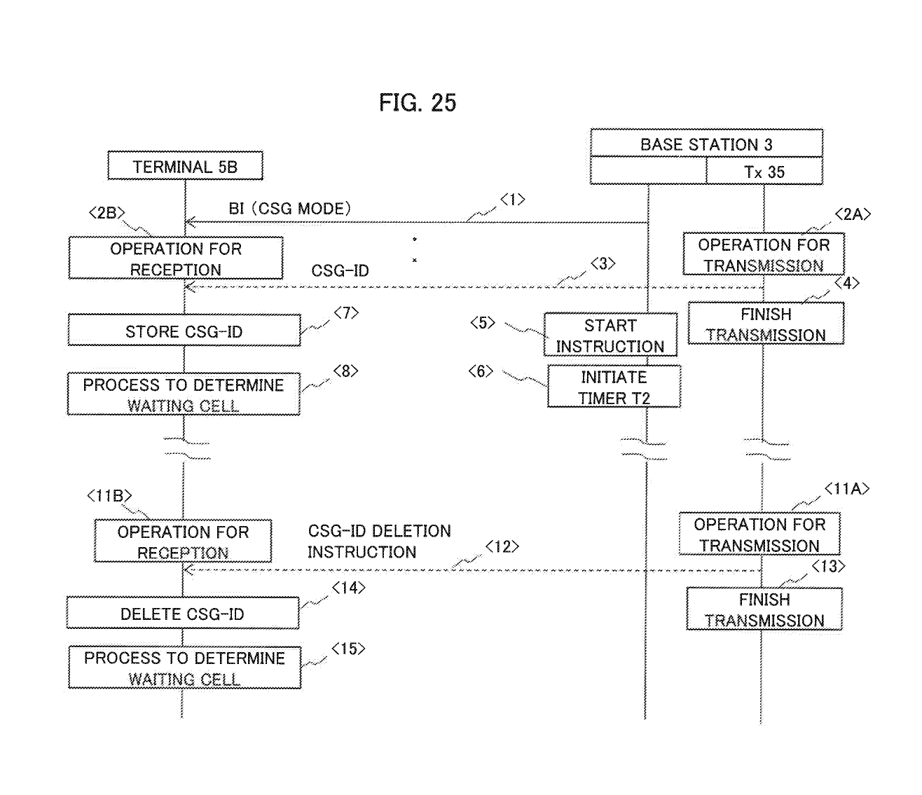

FIG. 25 is a sequence chart illustrating another form according to the third embodiment. FIG. 25 is based on the assumption that the transmitter 35 and the receiver 53 are each communication equipment for near field radio communication other than NFC, such as Bluetooth or Wi-Fi or infrared communication. If Bluetooth or Wi-Fi is employed, a difference in communication standard from a piece of broadcast information and employment of one-to-one communication allow a decrease in the possibility of storing a CSG-ID by the unexpected general radio terminal 5B.

In this case, an application for controlling the transmitter 35 is stored in a CF 23 of the specific base station 3. The CPU 25 executes the application, accepts an operation from the input device 31, and controls action of the transmitter 35 connected to a SW 21. Similarly, an application for controlling the receiver 53 is stored in a flash memory 45 of the general radio terminal 5B. The CPU 46 executes the application, accepts an operation from an input device 44, and controls action of the receiver 53.

As illustrated in FIG. 25, if a manager of the specific base station 3 desires to provide a CSG-ID to the general radio terminal 5B during transmission of a piece of broadcast information indicating CSG mode (<1> in FIG. 25), the manager operates the input device 31 to initiate the application for controlling the transmitter 35 and enters a CSG-ID transmission instruction. The CPU 25 controls the transmitter 35 through the execution of the application and makes the transmitter 35 ready to transmit a CSG-ID (<2A> in FIG. 25).

An owner of the general radio terminal 5B operates the input device 44 to initiate the application for controlling the receiver 53 and enters a CSG-ID reception instruction. The CPU 46 then controls the receiver 53 through the execution of the application and makes the receiver 53 ready to receive a CSG-ID (<2B> in FIG. 25). When the manager operates the input device 31 to enter a CSG-ID transmission instruction after that, the transmitter 35 transmits a CSG-ID (<3> in FIG. 25). When transmission for a predetermined period ends, the transmitter 35 ends the transmission processing (<4> in FIG. 25).

The operator (manager) of the specific base station 3 enters a start instruction through the input device 31 (<5>in FIG. 25). The CPU 25 of the specific base station 3 then initiates the timer T2 (<6> in FIG. 25) and is ready to accept a CSG-ID until the timer T2 expires.

In the general radio terminal 5B, the receiver 53 receives a CSG-ID. The received CSG-ID is stored in the storage area 471 by the receiver 53 or the CPU 46 (<7> in FIG. 25). When the CSG-ID is stored, the general radio terminal 5B can execute a waiting cell determination process (<6> in FIG. 25) to determine a CSG cell as a waiting cell. After that, the same actions as the actions indicated by <9> to <12> of FIG. 24 are performed. The actions are not illustrated, and a description thereof will be omitted.

In the third embodiment, a deletion process indicated by <11A>, <11B>, and <12> to <15> in FIG. 25 can be adopted. That is, the transmitter 35 transmits a CSG-ID deletion instruction for a predetermined period in response to a deletion instruction transmission operation (<11A> in FIGS. 25) (<12> and <13> in FIG. 25).

In the general radio terminal 5B, the receiver 53 receives a deletion instruction in response to a deletion instruction reception operation (<11B> in FIG. 25). The CPU 46 of the general radio terminal 5B deletes a CSG-ID from the storage area 471 in response to the deletion instruction (<14>in FIG. 25). Then, the waiting cell determination process is executed (<15> in FIG. 25), and the waiting cell is changed to another cell.

Note that any one of the CSG-ID deletion methods described in the first embodiment or utilization control of the specific base station 3 using a permission/prohibition bit (the second embodiment) can be employed in the third embodiment as well.

### Fourth Embodiment

A fourth embodiment will be described. The fourth embodiment has similarities to the first embodiment. Differences will be mainly described, and a description of the similarities will be omitted. The first embodiment is described a configuration in which a CSG-ID (access right information) is transmitted as apiece of broadcast information to the general radio terminal 5B. The fourth embodiment will describe a configuration in which a CSG-ID (access right information) is read from a one-dimensional code or a two-dimensional code by a general radio terminal 5B.

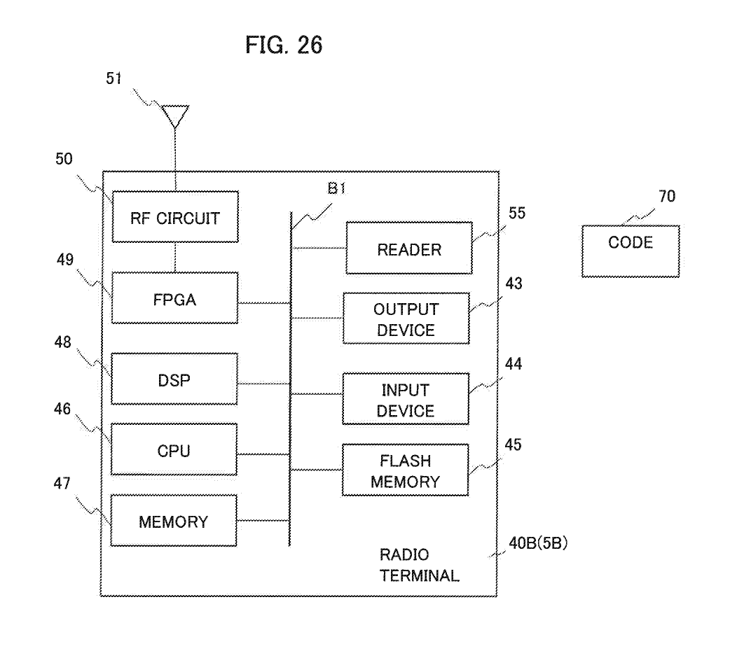

FIG. 26 illustrates an example of the configuration of a radio terminal 40B which can be employed as the general radio terminal 5B according to the fourth embodiment. The radio terminal 40B is different from the radio terminal 40 (FIG. 5) according to the first embodiment in that the radio terminal 40B further includes a reading device (code reader) 55 which is connected to a bus B1.

The reading device 55 is a reading device which reads a two-dimensional code 70 into which a CSG-ID is coded. The two-dimensional code 70 is a barcode as a two-dimensional symbol and is, for example, any one of a PDF417, a data matrix, a MaxiCode, and a QR Code (registered trademark). Note that the two-dimensional code 70 maybe a one-dimensional code (a barcode as a one-dimensional symbol).

The two-dimensional code 70 may be, for example, printed, pasted, or drawn on the surface of a housing of the specific base station 3. A print medium, such as a sheet with the printed two-dimensional code 70, maybe managed separately from the specific base station 3.

The reading device 55 includes a scanner which scans the two-dimensional code 70 and a decoder (decoding circuit) which decodes electrical information obtained from the scanner into a character code. The scanner is, for example, a two-dimensional imager using a digital camera. Note that the scanner may be a scanner using a scan method other than that of a two-dimensional imager. A CSG-ID obtained through decoding processing by the decoder is stored in a storage area 471 by the reading device 55 or a CPU 46.

An application for controlling the reading device 55 is stored in a flash memory 45 of the general radio terminal 5B. The CPU 46 executes the application, accepts an operation from an input device 44, and controls action of the reading device 55.

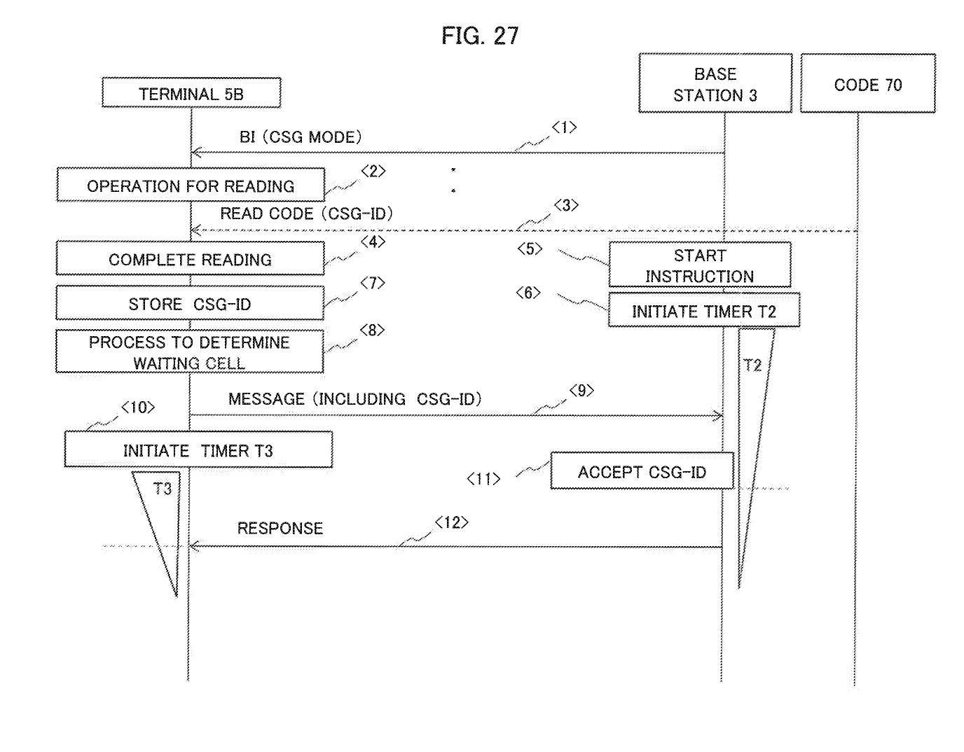

FIG. 27 is a sequence chart illustrating action when a general radio terminal sets a CSG cell for a specific base station as a waiting cell according to the fourth embodiment. In the fourth embodiment, the specific base station 3 does not switch from CSG mode to hybrid mode and always broadcasts apiece A of broadcast information (CSG mode) (<1> in FIG. 27).

An owner of the general radio terminal 5B operates the input device 44 to initiate the application for controlling the reading device 55 (the CPU 46 starts execution of the application). The owner operates the input device 44 while referring to an image shot by a camera displayed on an output device 43 (a display) upon the initiation of the application and shoots the two-dimensional code 70 (<2> in FIG. 27).

The reading device 55 then performs image processing and decoding processing of the two-dimensional code 70 to obtain a CSG-ID (<3> in FIG. 27). Note that the CPU 46 may execute part of the image processing and the decoding processing.

When the reading is completed, completion of the reading is broadcast to an operator of the specific base station 3 through at least one of sound from, light from, display of information on, and vibration from the output device 32 (<4>in FIG. 27). The actions in <5> to <12> of FIG. 27 are the same as those in the third embodiment, and a description thereof will be omitted.

In the fourth embodiment, any one of the first to fifth CSG-ID deletion methods (the first embodiment) can be employed for a CSG-ID stored in the storage area 471. Alternatively, the utilization control of the specific base station 3 using a permission/prohibition bit (the second embodiment) described in the second embodiment can also be employed.

According to the fourth embodiment, it is possible to obtain a CSG-ID from the two-dimensional code 70 and store the CSG-ID in the storage area 471. Unlike the first and third embodiments, communication is not executed for delivery and receipt of a CSG-ID. This prevents the general radio terminal 5B not intended by the manager of the specific base station 3 from storing a CSG-ID.

A radio terminal 5 often includes a reading device for the two-dimensional code 70. For this reason, the general radio terminal 5B described in the fourth embodiment can be formed by implementing an application for CSG-ID storage in the general radio terminal 5B using such a reading device.

The configurations described in the first to fourth embodiments can be appropriately combined without departing from the object of the disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station permitting a specified radio terminal with an access right to utilize the base station, comprising:
a controller configured to perform processes including counting down for a predetermined period when receiving a start instruction and permitting utilization of the base station by a general radio terminal without the access right when accepting access right information from the general radio terminal before expiration of the predetermined period.

2. The base station according to claim 1, further comprising a transmitter configured to transmit broadcast information including the access right information in a manner which allows reception by the general radio terminal.

3. The base station according to claim 2, wherein the controller is configured to perform a process to transmit the broadcast information including the access right information with transmission power lower than transmission power for different broadcast information.

4. The base station according to claim 1, further comprising a communication device configured to transmit the access right information to the general radio terminal through near field radio communication or infrared communication.

5. The base station according to claim 1, wherein the controller is configured to transmit an instruction to delete the access right information toward the general radio terminal with the access right information.

6. The base station according to claim 1, wherein the control device is configured to perform the processes further including transmitting broadcast information indicating permission for utilization of the base station to a general radio terminal with the access right information and, when the access right information transmitted from a general radio terminal receiving the broadcast information is received before expiration of the predetermined period, permitting utilization of the base station by the general radio terminal.

7. A radio terminal without a right of access to a specified base station, comprising:
a device configured to obtain access right information to the specified base station by receiving the access right information or reading a one-dimensional or two-dimensional code corresponding to the access right information;
a storage configured to store the access right information; and
a controller configured to performs processes including determining a cell formed by the specified base station as a waiting cell under a condition that the access right information is stored in the storage, transmitting the access right information to the specified base station when the cell of the specified base station is determined as the waiting cell, and deleting the access right information from the storage when a response indicating permission of utilization of the specified base station is not received within a predetermined period after transmitting the access right information.

8. The radio terminal according to claim 7, wherein the device includes a radio communication device configured to receive broadcast information including an instruction to store the access right information from the specified base station.

9. The radio terminal according to claim 7, wherein the device includes a communication device configured to receive the access right information through near field radio communication or infrared communication with the specified base station or a communication apparatus different from the specified base station.

10. The radio terminal according to claim 7, wherein the controller deletes the access right information stored in the storage when an instruction to delete the access right information is received from the specified base station or a communication apparatus different from the specified base station.

11. The radio terminal according to claim 7, wherein the controller deletes the access right information stored in the storage device when the waiting cell is changed to a cell different from the cell formed by the specified base station.

12. The radio terminal according to claim 7, wherein the controller deletes the access right information stored in the storage device when the waiting cell is not changed to the cell formed by the specified base station within a predetermined time period after the waiting cell is changed to a cell different from the cell formed by the specified base station.

13. The radio terminal according to claim 7, wherein the controller determines the cell formed by the specified base station as the waiting cell when the access right information is in the storage and broadcast information indicating permission of utilization of the specified base station is received.
